(19) United States
(12) Patent Application Publication
(10) Pub. No.: US 2024/0251272 A1
(43) Pub. Date: Jul. 25, 2024

(54) ACKNOWLEDGEMENT OF UE INITIATED REPORTING

(71) Applicant: Samsung Electronics Co., Ltd., Suwon-si (KR)

(72) Inventors: Emad Nader Farag, Flanders, NJ (US); Md. Saifur Rahman, Plano, TX (US); Eko Onggosanusi, Coppell, TX (US); Dalin Zhu, Allen, TX (US); Gilwon Lee, McKinney, TX (US)

(21) Appl. No.: 18/410,930

(22) Filed: Jan. 11, 2024

Related U.S. Application Data
(60) Provisional application No. 63/441,129, filed on Jan. 25, 2023.

(51) Int. Cl. H04W 24/10; H04W 72/21; H04W 72/232

(52) U.S. Cl. CPC H04W 24/10; H04W 72/21; H04W 72/232

(57) ABSTRACT

A user equipment (UE) includes a transceiver. The transceiver is configured to receive information about transmission of UE initiated reports in a first uplink (UL). The UE further includes a processer operably coupled to the transceiver. The processor is configured to determine a two-part UL report. The transceiver is further configured to transmit, based on the information, the first UL including a first part of the two-part UL report, and receive a first acknowledgment within a time, T from the transmission of the first UL.

### CROSS-REFERENCE TO RELATED APPLICATION(S) AND CLAIM OF PRIORITY

This application claims priority under 35 U.S.C. § 119(e) to U.S. Provisional Patent Application No. 63/441,129 filed on Jan. 25, 2023. The above-identified provisional patent application is hereby incorporated by reference in its entirety.

### TECHNICAL FIELD

This disclosure relates generally to wireless networks. More specifically, this disclosure relates to methods and apparatuses for acknowledgment of UE initiated reporting.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides methods and apparatuses for acknowledgment of UE initiated reporting.

In one embodiment, a user equipment (UE) is provided. The UE includes a transceiver. The transceiver is configured to receive information about transmission of UE initiated reports in a first uplink (UL). The UE further includes a processer operably coupled to the transceiver. The processor is configured to determine a two-part UL report. The transceiver is further configured to transmit, based on the information, the first UL including a first part of the two-part UL report, and receive a first acknowledgment within a time, T from the transmission of the first UL.

In another embodiment, a base station (BS) is provided. The BS includes a transceiver. The transceiver is configured to transmit information about transmission of UE initiated reports in a first UL, and receive, based on the information, the first UL including a first part of a two-part UL report. The BS further includes a processor operably coupled to the transceiver. The processor is configured to determine a first acknowledgment for the first UL. The transceiver is further configured to transmit the first acknowledgment within a time, T from the reception of the first UL.

In yet another embodiment, a method of operating a UE is provided. The method includes receiving information about transmission of UE initiated reports in a first uplink (UL), determining a two-part UL report, transmitting, based on the information, the first UL including a first part of the two-part UL report; and receiving a first acknowledgment within a time, T from the transmission of the first UL.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to this disclosure;

FIG. 3A illustrates an example UE according to embodiments of the present disclosure;

FIG. 3B illustrates an example gNB according to embodiments of the present disclosure;

FIGS. 4A-4B illustrate examples of beams according to embodiments of the present disclosure;

FIG. 5 illustrates example antenna blocks or arrays according to embodiments of the present disclosure;

FIG. 6 illustrates an example of UE configuration/updating according to embodiments of the present disclosure;

FIGS. 7-10 illustrate example processes for RS measurement by a UE according to embodiments of the present disclosure;

FIGS. 11-14 illustrate example processes for RS measurement by a network according to embodiments of the present disclosure;

FIG. 15 illustrates an example procedure for UE initiated measurement and/or reporting according to embodiments of the present disclosure;

FIG. 16 illustrates an example of a signaling exchange between a network and a UE according to embodiments of the present disclosure;

FIG. 17 illustrates an example of a UE sending a pre-notification channel/signal to a network according to embodiments of the present disclosure;

FIG. 18 illustrates an example of a UE sending a pre-notification channel/signal to a network without receiving an acknowledgment according to embodiments of the present disclosure;

FIG. 19 illustrates an example of a UE sending a first stage/part and a second stage/part of a report to a network according to embodiments of the present disclosure;

FIG. 20 illustrates an example of a UE sending a first stage/part and a second stage/part of a report to a network without receiving an acknowledgment according to embodiments of the present disclosure;

FIG. 21 illustrates an example of applying a parameter update at a particular time according to embodiments of the present disclosure;

FIG. 22 illustrates an example of applying a parameter update at a particular time and after acknowledgment of a UE report according to embodiments of the present disclosure;

FIG. 23 illustrates an example of reverting to an original parameter value after failing to receive an acknowledgment of a UE report according to embodiments of the present disclosure;

FIG. 24 illustrates an example of applying a parameter update at a particular time after acknowledgment of a UE report according to embodiments of the present disclosure;

FIG. 25 illustrates an example of applying a parameter update at a particular time after receiving a first or second part of a UE report according to embodiments of the present disclosure;

FIG. 26 illustrates an example of applying a parameter update at a particular time and after acknowledgment of a two stage UE report according to embodiments of the present disclosure;

FIG. 27 illustrates an example of reverting to an original parameter value after failing to receive an acknowledgment of a two stage UE report according to embodiments of the present disclosure;

FIG. 28 illustrates an example 2800 of applying a parameter update at a particular time after acknowledgment of a two stage UE report according to embodiments of the present disclosure; and

FIG. 29 illustrates a method for acknowledgment of UE initiated reporting according to embodiments of the present disclosure.

### DETAILED DESCRIPTION

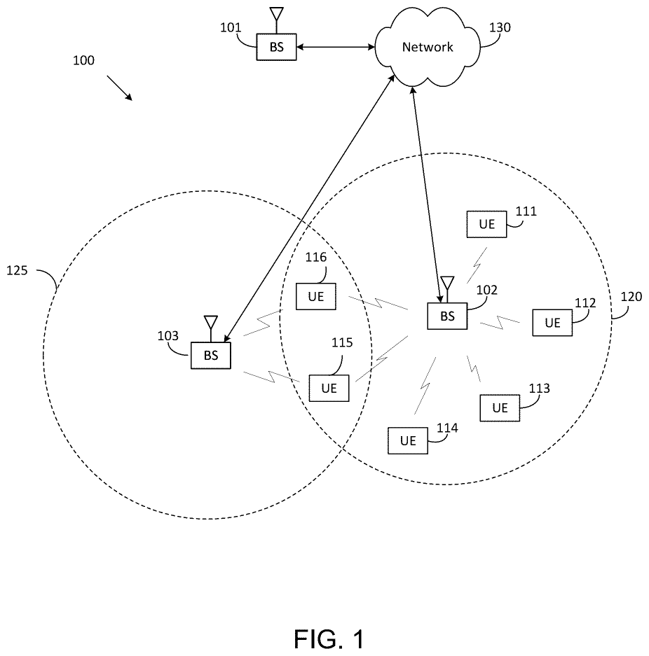

FIGS. 1 through 29, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for acknowledgment of UE initiated reporting. In certain embodiments, one or more of the gNBs 101-103 includes circuitry, programing, or a combination thereof, to support acknowledgment of UE initiated reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

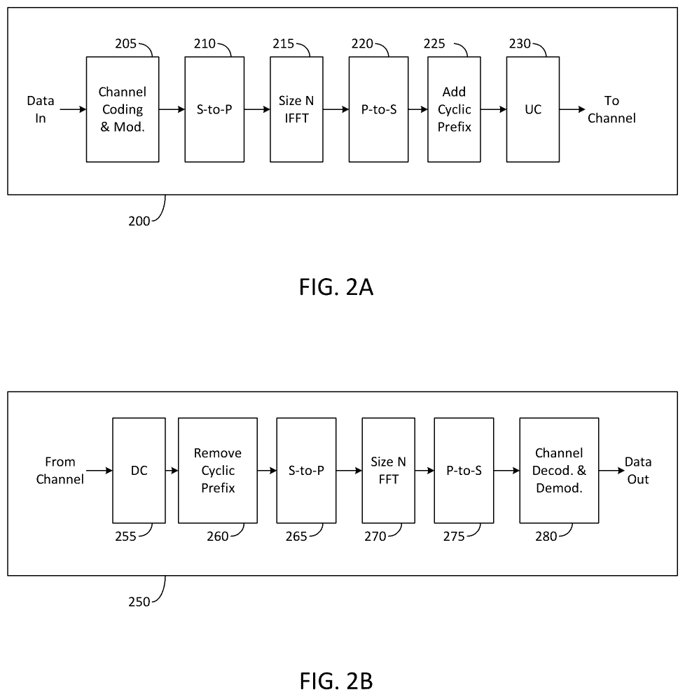

FIGS. 2A and 2B illustrate example wireless transmit and receive paths according to this disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

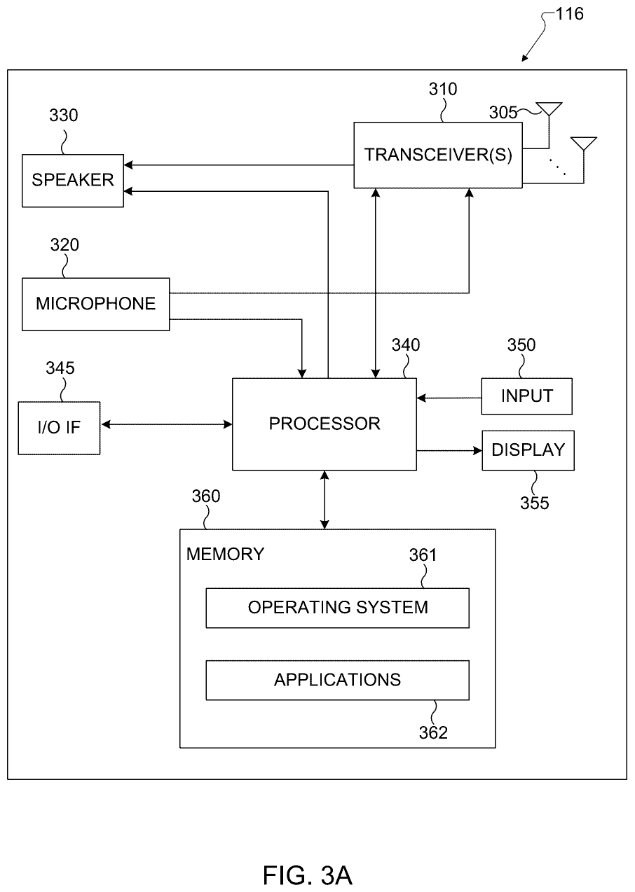

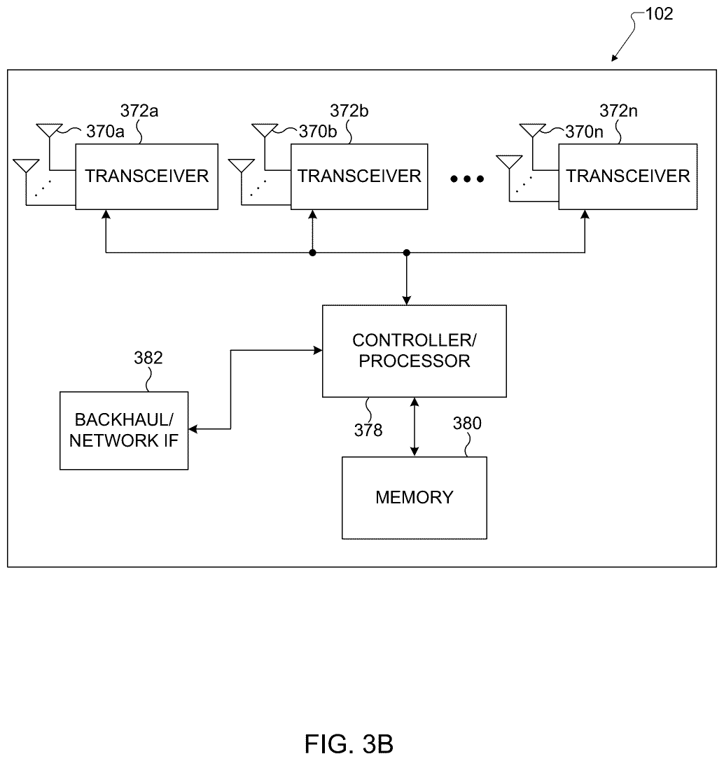

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for acknowledgment of UE initiated reporting as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support acknowledgment of UE initiated reporting as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The following documents and standards descriptions are hereby incorporated into the present disclosure as if fully set forth herein:
[1] 3GPP TS 38.211 v 18.0.0, “NR; Physical channels and modulation.”
[2] 3GPP TS 38.212 v 18.0.0, “NR; Multiplexing and Channel coding.”
[3] 3GPP TS 38.213 v 18.0.0, “NR; Physical Layer Procedures for Control.”
[4] 3GPP TS 38.214 v 18.0.0, “NR; Physical Layer Procedures for Data.”
[5] 3GPP TS 38.321 v 17.6.0, “NR; Medium Access Control (MAC) protocol specification.”
[6] 3GPP TS 38.331 v 17.6.0, “NR; Radio Resource Control (RRC) Protocol Specification.”
[7] 3GPP RP-202024, “Revised WID: Further enhancements on MIMO for NR”.

In the present disclosure, a beam is determined by either of:
A transmission configuration indication (TCI) state, that establishes a quasi-colocation (QCL) relationship or spatial relation between a source reference signal (e.g., a synchronization signal block (SSB) and/or channel state information (CSI)-reference signal (RS) and/or sounding reference signal (SRS)) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial RX filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial RX filter for reception of uplink channels at the gNB.

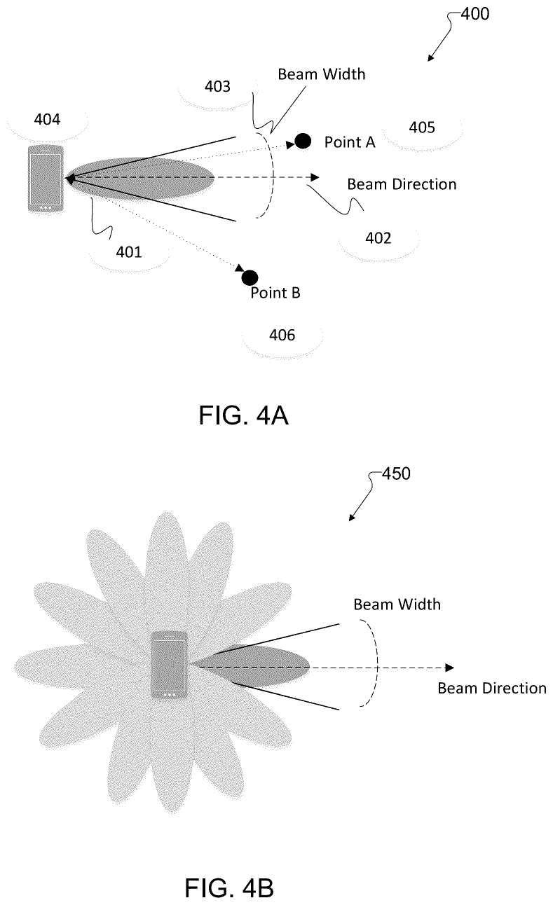

FIGS. 4A-4B illustrate examples 400 and 450 of beams according to embodiments of the present disclosure. The embodiments of beams of FIGS. 4A-4B are for illustration only. Different embodiments of beams could be used without departing from the scope of this disclosure.

As illustrated in FIG. 4A, in a wireless system a beam (401), for a device (404), can be characterized by a beam direction (402) and a beam width (403). For example, a device (404) transmits radio frequency (RF) energy in a beam direction and within a beam width. A device (404) receives RF energy in a beam direction and within a beam width. As illustrated in FIG. 4A, a device at point A (405) can receive from and transmit to device (404) as Point A is within a beam width and direction of a beam from device (404). As illustrated in FIG. 4A, a device at point B (406) cannot receive from and transmit to device (404) as Point B is outside a beam width and direction of a beam from device (404). While FIG. 4A, for illustrative purposes, shows a beam in 2-dimensions (2D), it should be apparent to those skilled in the art, that a beam can be in 3-dimensions (3D), where the beam direction and beam width are defined in space.

In a wireless system, a device can transmit and/or receive on multiple beams. This is known as “multi-beam operation” and is illustrated in FIG. 4B. While FIG. 4B, for illustrative purposes, a beam is in 2D, it should be apparent to those skilled in the art, that a beam can be 3D, where a beam can be transmitted to or received from any direction in space.

Although FIGS. 4A-4B illustrate examples 400 and 450 of beams, various changes may be made to FIGS. 4A-4B. For example, various changes to the beam width, the beam direction, the number of beams, etc. could be made according to particular needs.

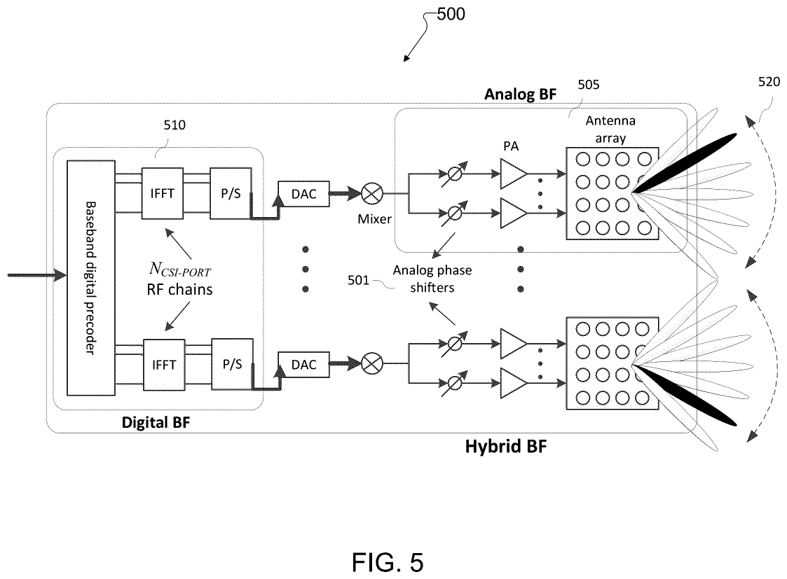

FIG. 5 illustrates example antenna blocks or arrays 500 according to embodiments of the present disclosure. The embodiment of the antenna blocks or arrays 500 illustrated in FIG. 5 is for illustration only. Different embodiments of antenna blocks or arrays 500 could be used without departing from the scope of this disclosure.

Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of ADCs/DACs at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles (520) by varying the phase shifter bank across symbols or slots/subframes. The number of sub-arrays (equal to the number of RF chains) is same as the number of CSI-RS ports NeSI-PORT. A digital beamforming unit 510 performs a linear combination across NeSI-PORT analog beams to further increase a precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence larger number of radiators in the array) are needed to compensate for the additional path loss.

Although FIG. 5 illustrates one example antenna blocks or arrays 500, various changes may be made to FIG. 5. For example, various components in FIG. 5 could be combined, further subdivided, or omitted and additional components could be added according to particular needs.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is a TCI state of UE-dedicated reception on physical downlink shared channel (PDSCH)/physical downlink control channel (PDCCH) or dynamic-grant/configured-grant based physical uplink shared channel (PUSCH) and all of dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214—section 5.1.5]:
Type A, {Doppler shift, Doppler spread, average delay, delay spread}
Type B, {Doppler shift, Doppler spread}
Type C, {Doppler shift, average delay}
Type D, {Spatial RX parameter}

In addition, quasi-co-location relation and a source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., the same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g., non-UE dedicated channel and sounding reference signal (SRS).

A UE is indicated a TCI state by a medium access control (MAC) control element (CE) when the CE activates one TCI state code point. The UE applies the TCI state code point after a beam application time from the corresponding hybrid automatic repeat request (HARQ)-acknowledgement (ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI Format can be with a DL assignment or without a DL assignment. A TCI state (TCI state code point) indicated in a DL related DCI format is applied after a beam application time from the corresponding HARQ-ACK feedback.

In the present disclosure UE-initiated reporting is considered. For example, aspects related to acknowledgment of a UE initiated report and timing aspects related to application of parameters based on the UE initiated report at a UE and a base station are disclosed. Acknowledgement can be for a pre-notification channel/signal from the UE or for the UE-initiated report.

In release 15 and release 16 a common framework is shared for CSI and beam management. While the complexity of such framework is justified for CSI in FR1, it makes beam management procedures rather cumbersome and less efficient in FR2. Efficiency in this scenario refers to overhead associated with beam management operations and latency for reporting and indicating new beams.

Furthermore, in release 15 and release 16, the beam management framework is different for different channels. This increases the overhead of beam management and could lead to less robust beam-based operation. For example, for PDCCH the TCI state (used for beam indication), is updated through MAC CE signaling. While the TCI state of PDSCH can be updated through a DL DCI carrying the DL assignment with codepoints configured by MAC CE, or the PDSCH TCI state can follow that of the corresponding PDCCH, or use a default beam indication. In the uplink direction, the spatialRelationInfo framework is used for beam indication for PUCCH and SRS, which is updated through radio resource control (RRC) and MAC CE signaling. For PUSCH the SRS Resource Indicator (SRI), in an UL DCI with UL grants, can be used for beam indication. Having different beam indications and beam indication update mechanisms increases the complexity, overhead and latency of beam management, and could lead to less robust beam-based operation.

Rel-17 introduced the unified TCI framework, wherein a unified or master or main or indicated TCI state is signaled to the UE. RRC signaling configures Rel-17 TCI states. MAC signaling can activate one or more TCI codepoints. When one TCI state codepoint is activated by a MAC CE, the UE applies the TCI state(s) associated with the activated codepoint after a beam application time. When multiple TCI codepoints are activated by a MAC CE, further DCI signaling is used to indicate a TCI state codepoint to the UE. The unified TCI state can be signaled by a DCI Format (e.g., DL related DCI Format (e.g., DCI Format 1_1 or DCI Format 1_2) with a DL assignment or a DL related DCI Format (e.g., DCI Format 1_1 or DCI Format 1_2) without a DL assignment.

For UE measurement and reporting, the network can configure and/or activate and/or trigger a reference signal (RS) that is transmitted by the network and measured by the UE or an RS that is transmitted by the UE and measured by the network. The network can also configure and/or activate and/or trigger the channel used to report the measurement performed by the UE to the network. In some cases, such operation can lead to additional latency, as the UE has to wait for the network to configure and/or activate and/or trigger the RS and/or channel for reporting the measurement. In some cases, such operation can lead to additional overhead as resources are being configured for the measurement RS and/or channel for reporting measurement, when the report has not changed between consecutive instances of reporting leading to inefficient utilization of air interface resources.

To mitigate, the previously mentioned, latency and/or overhead issues, UE initiated measurement and reporting is considered. The procedure for UE initiated measurement and/or reporting includes the following steps:
In step 1, the UE can send a pre-notification or request signal to the gNB.
In step 2, the network can respond with signal providing resources and configuration for transmission of a report that includes measurements performed by the UE.
In step 3, the UE provides a report.
In step 4, the UE and/or the base station can apply or update a parameter based on the report. In some scenarios, the timing of the application of the report should be aligned at the UE and the base station.

The present disclosure considers the acknowledgment of a UE initiated report. The acknowledgment can be for the pre-notification channel/signal and/or for the channel or signal carrying a UE initiated report. In some scenarios, one or more parameters can be updated based on the UE initiated report, at the UE and the base station. For example, the TCI state used for downlink and/or uplink channels or signals can be updated based on the UE initiated report. In some scenarios, the update of the one or more parameters should be aligned between the UE and base station. The present disclosure also considers aspects related to the timing of parameter update based on a UE initiated report.

With respect to the present disclosure, both frequency division duplexing (FDD) and time division duplexing (TDD) are considered as a duplex method for DL and UL signaling.

Although exemplary descriptions and embodiments described herein assume orthogonal frequency division multiplexing (OFDM) or orthogonal frequency division multiple access (OFDMA), embodiments of the present disclosure can be extended to other OFDM-based transmission waveforms or multiple access schemes such as filtered OFDM (F-OFDM).

The present disclosure considers several components that can be used in conjunction or in combination with one another, or can operate as standalone schemes.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the present disclosure, RRC signaling (e.g., configuration by RRC signaling) includes the following: (1) system information block (SIB)-based RRC signaling (e.g., SIBI or other SIB) and/or (2) RRC dedicated signaling that is sent to a specific UE.

In the present disclosure, a MAC CE signaling includes: (1) DL MAC CE signaling from gNB or network to UE, when transmitted by gNB, and/or (2) UL MAC CE signaling from UE to gNB, when transmitted from UE.

In the present disclosure, an L1 control signaling includes: (1) DL control information (e.g., DCI on PDCCH) when transmitted from the gNB or network to UE, and/or (2) UL control information (e.g., UCI on PUCCH or PUSCH) when transmitted from UE.

Terminology such as TCI, TCI states, SpatialRelationInfo, target RS, reference RS, and other terms are used for illustrative purposes and are therefore not normative. Other terms that refer to the same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission) and apply the known characteristics of the source RS to the assigned DL transmission (and/or UL transmission). The source RS can be received and measured by the UE (in this case, the source RS is a downlink measurement signal such as non-zero-power (NZP) CSI-RS and/or SSB) with the result of the measurement being used for calculating a beam report (e.g., including at least one L1-reference signal received power (RSRP)/L1-signal to interference and noise ratio (SINR) accompanied by at least one CSI-RS resource indicator (CRI) or SSB resource indicator (SSBRI)). As the network (NW)/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE.

In the following examples, a TCI state is used for beam indication. In the present disclosure, TCI state can refer to a DL TCI state for downlink channels (e.g., PDCCH and PDSCH) or downlink signals, an uplink TCI state for uplink channels (e.g., PUSCH or PUCCH) or uplink signals, a joint TCI state for downlink and uplink channels/signals, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by a SRS resource indicator (SRI).

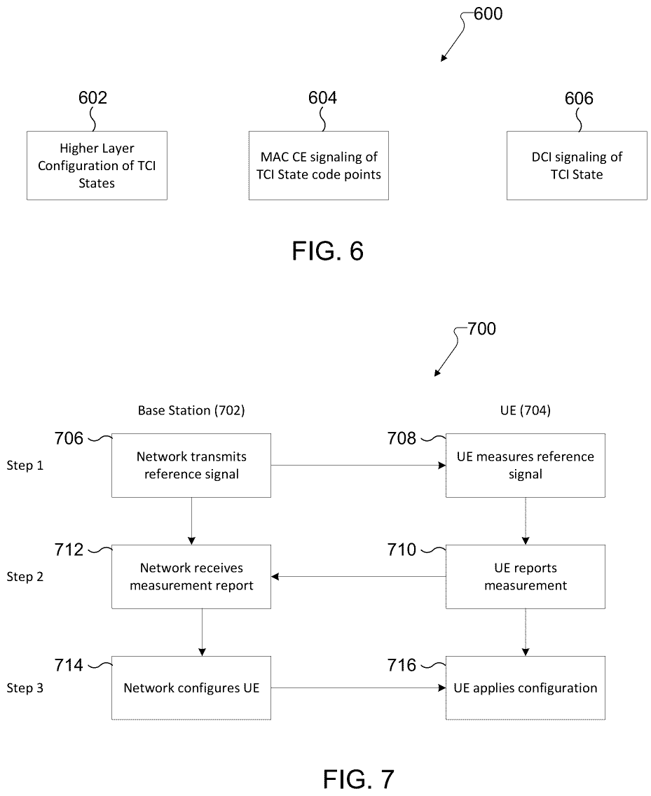

FIG. 6 illustrates an example 600 of UE configuration/updating according to embodiments of the present disclosure. The embodiment of UE configuration/updating of FIG. 6 is for illustration only. Different embodiments of UE configuration/updating could be used without departing from the scope of this disclosure.

In the following examples, as illustrated in FIG. 6, a UE is configured/updated through higher layer RRC signaling a set of TCI States 602 with L elements. In one example, DL and joint TCI states are configured by higher layer parameter DLorJoint-TCIState, wherein, the number of DL and Joint TCI state is L_{DJ}. UL TCI state are configured by higher layer parameter UL-TCIState, wherein the number of UL TCI state is L_{U}·L=L_{DJ}+L_{U}, wherein L is the total number of DL, Joint and UL TCI states.

MAC CE signaling 604 includes a subset of K (K≤L) TCI states or TCI state code points from the set of L TCI states, wherein a code point is signaled in the “transmission configuration indication” field of a DCI 606 used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e. Downlink Control Information (DCI)) updates the UE's TCI state, wherein the DCI includes a “transmission configuration indication” (beam indication) field e.g., with k bits (such that K≤2^{k}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The TCI states can be associated, through a QCL relation, with an SSB of serving cell, or an SSB associated with a PCI different from the PCI of the serving cell. The QCL relation with a SSB can be a direct QCL relation, wherein the source RS (e.g., for a QCL Type D relation or a spatial relation) of the QCL state is the SSB. The QCL relation with a SSB can be an indirect QCL relation, wherein, the source RS (e.g., for a QCL Type D relation or a spatial relation) can be a reference signal, and the reference signal has the SSB as its source (e.g., for a QCL Type D relation or a spatial relation). The indirect QCL relation to an SSB can involve a QCL or spatial relation chain of more than one reference signal.

The UE can use a DL related DCI (e.g., DCI Format 1_1 or DCI Format 1_2) without DL assignment, for beam indication. For example, the use of DL related DCI without DL assignment, can be configured by higher layers, or can be specified in the system specification.

Alternatively, the UE can use a DL related DCI (e.g., DCI Format 1_1 or DCI Format 1_2) with DL assignment, for beam indication. For example, the use of DL related DCI with DL assignment, can be configured by higher layers, or can be specified in the system specification.

Although FIG. 6 illustrates an example 600 of UE configuration/updating, various changes may be made to FIG. 6. For example, various changes to the TCI states, the TCI state code points, the signaling, etc. could be made according to particular needs.

In the following examples, the “transmission configuration indication” provided by a DCI format includes a TCI state codepoint activated by MAC CE. Wherein, the TCI state codepoint can be one of:
Joint TCI state used for UL transmissions and DL receptions by the UE.
DL TCI state used for DL receptions by the UE.
UL TCI state used for UL transmissions by the UE.
DL TCI state used for DL receptions by the UE and UL TCI states used for UL transmissions by the UE.

FIGS. 7-10 illustrate an example processes 700-1000 for RS measurement by a UE according to embodiments of the present disclosure. The embodiments of processes 700-1000 for RS measurement by a UE of FIGS. 7-10 are for illustration only. One or more of the components illustrated in FIGS. 7-10 may be implemented in specialized circuitry configured to perform the noted functions or one or more of the components may be implemented by one or more processors executing instructions to perform the noted functions. Other embodiments of processes 700-1000 for RS measurement by a UE could be used without departing from the scope of this disclosure.

In the example of FIG. 7, at step 1 a network (e.g., base Station (BS), gNB or transmission/reception point (TRP)) 702 transmits a reference signal (RS) at block 706, and the UE 704 measures the RS at block 708. At step 2, UE 704 reports the measurement to network 702 at block 710, and network 702 receives the measurement at block 712. At step 3, network 702 further configures UE 704 based on the measured reference signal at block 714, and UE 704 applies the configuration at block 716.

In step 1 of FIG. 7, the RS can be:
(1) SSB and/or
(2) a non-zero power channel state information reference signal (NZP CSI-RS) and/or
(3) a demodulation reference signal (DMRS) associated with a PDSCH and/or PDCCH.

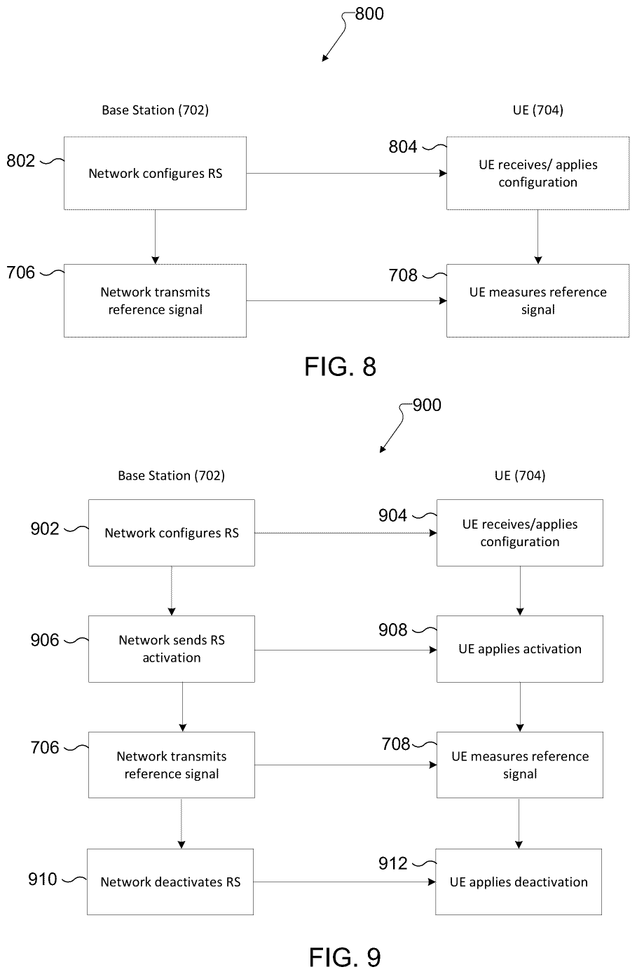

In step 1 of FIG. 7, in one embodiment the RS can be a periodically configured RS similar as illustrated in example 800 of FIG. 8. In the example of FIG. 8, network 702 configures the RS at block 802 (e.g., using higher layer configuration such as RRC configuration), and UE 704 receives/applies the configuration at block 804. The network then transmits the RS based on the configuration at block 706 and UE 704 measures the reference signal at block 708 similar as illustrated in FIG. 7.

In step 1 of FIG. 7, in one embodiment, the RS can be a semi-persistent RS similar as illustrated in example 900 of FIG. 9. In the example of FIG. 9, network 702 configures the RS at block 902 (e.g., using higher layer configuration such as RRC configuration) and UE 704 receives/applies the configuration at block 904. However, the RS is not transmitted until the RS is activated at bock 906. For example, activation signaling can be MAC CE signaling and/or L1 control signaling (e.g., DCI signaling). UE 704 receives the activation signaling and applies activation at block 908. After the RS is activated, the RS is transmitted at block 706 (e.g., periodically) and UE 704 measures the reference signal at block 708 similar as illustrated in FIG. 7 until the RS is deactivated at block 910, and UE 704 applies the deactivation at block 912. For example, deactivation signaling can be MAC CE signaling and/or L1 control signaling (e.g., DCI signaling). After the RS is deactivated, the RS is not transmitted until further activation.

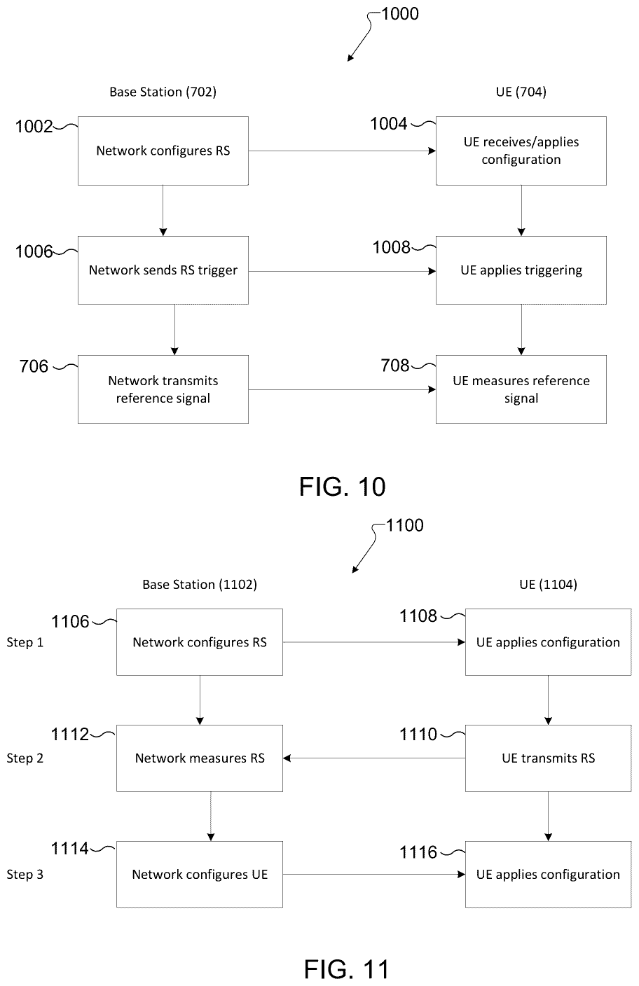

In step 1 of FIG. 7, in one embodiment, the RS can be an aperiodic RS similar as illustrated in example 1000 FIG. 10. In the example of FIG. 10, network 702 configures the RS at block 1002 (e.g., using higher layer configuration such as RRC configuration) and UE 704 receives/applies the configuration at block 1004. But the RS is not transmitted until it is triggered at block 1006. UE 704 receives RS trigger signaling and applies activation at block 1008. For example, trigger signaling can be L1 control signaling (e.g., DCI signaling) and/or MAC CE signaling. In one example, trigger signaling can trigger one transmission instance of RS. In another example trigger signaling can trigger N transmission instances of RS. Wherein, N can be specified in specifications and/or configured by higher layer signaling (e.g., RRC signaling and/or MAC CE signaling) and/or configured by L1 control signaling (e.g., DCI signaling) and/or included in the message triggering the transmission of the RS. The network then transmits the RS at block 706 and UE 704 measures the reference signal at block 708 similar as illustrated in FIG. 7.

In step 1 of FIG. 7, the measurement can be:
(1) Beam related measurement (e.g., L1-RSRP measurement and/or L1-SINR measurement).
(2) Mobility (e.g., handover) measurement (e.g., L1-RSRP measurement, L3-RSRP measurement, L1-SINR measurement and/or RSRQ measurement).
(3) channel state information (CSI) related measurement (e.g., for CQI and/or for PMI and/or for RI).
(4) Time domain channel properties (TDCP) measurement (e.g., for Doppler profile and/or auto correlation profile.
(5) Time related measurements (e.g., time of arrival difference of RS from different transmission points).
(6) Other non-beam, non-mobility, non-CSI, non-TDCP, non-time related measurements.

In step 2 of FIG. 7, UE 704 provides the measurement report to the network. The measurement report can be:
(1) Periodic measurement report. The network configures the measurement (e.g., using higher layer configuration such as RRC configuration). The UE then transmits the measurement report based on the configuration.
(2) Semi-persistent measurement report. The network configures the measurement report (e.g., using higher layer configuration such as RRC configuration). But The measurement report is not transmitted until it is activated. For example, activation signaling can be MAC CE signaling and/or L1 control signaling (e.g., DCI signaling). After the measurement report is activated, the measurement report is transmitted (e.g., periodically) until the measurement report is deactivated. For example, deactivation signaling can be MAC CE signaling and/or L1 control signaling (e.g., DCI signaling). After the measurement report is deactivated, the measurement report is not transmitted until further activation. In one example, the activation or deactivation for an RS can also activate or deactivate the measurement report or vice versa.
(3) Aperiodic measurement report. The network configures the measurement report (e.g., using higher layer configuration such as RRC configuration). But the measurement report is not transmitted until it is triggered. For example, trigger signaling can be L1 control signaling (e.g., DCI signaling) and/or MAC CE signaling. In one example, trigger signaling can trigger one transmission instance of measurement report. In another example trigger signaling can trigger N transmission instances of measurement report. Wherein, N can be specified in specifications and/or configured by higher layer signaling (e.g., RRC signaling and/or MAC CE signaling) and/or configured by L1 control signaling (e.g., DCI signaling) and/or included in the message triggering the transmission of the measurement report. In one example, the trigger for an RS can also trigger the measurement report.

In step 2 of FIG. 7, the measurement report can be transmitted using at least one of the following UL transmissions:
(1) PUSCH, wherein the PUSCH can be a dynamically scheduled PUSCH and/or a configure grant PUSCH (e.g., Type 1 configured grant and/or Type 2 configured grant).
(2) PUCCH.
(3) RACH, wherein RACH can be Type 1 RACH and/or Type 2 RACH, further, more RACH can be contention based random access (CBRA) and/or contention free random access (CFRA), further, more RACH can be triggered by higher layers or triggered by a PDCCH order.

In step 2 of FIG. 7, the measurement report can be:
(1) a one-part (or one stage) measurement report.
(2) a two-part (or two-stage) measurement report, for example the first part can have a fixed size and it provides information about the second part, e.g., size and/or content and/or resources of the second part.

In step 2 of FIG. 7, the measurement report can be, or can included one or more of the following:
(1) a report for beam measurements (e.g., including L1-RSRP and/or L1-SINR and/or beam indicator).
(2) a report for mobility (or handover) measurements (e.g., including L1-RSRP and/or L3-RSRP and/or L1-SINR and/or RSRQ and/or beam indicator and/or cell indicator)
(3) a report for CSI related measurements (e.g., including CSI and/or PMI and/or RI and/or L1 and/or CRI)
(4) a report for TDCP related measurements (e.g., including TDCP-related quantity/quantities and/or indicator (s) for Doppler profile and/or indicator (s) for auto-correlation profile).
(5) A report for time related measurements (e.g., including time of arrival difference of RS from different transmission points)
(6) A report for other non-beam, non-mobility, non-CSI, non-TDCP, non-time related measurements.

In one example, the contents and frequency of occurrence of the report depend on the channel conditions. In one example, in a fast changing environment the reports are more frequent. In one example, in a slow changing environment the reports are less frequent. In one example, the report can include predicted channel conditions (e.g., predicted measurements) at a time in the future.

In step 3 of FIG. 7, after receiving the measurement report the network takes action based on the measurement report and UE 704 applies the indicated action. For example, the action be one of:
(1) Application of a new beam (e.g., TCI state or spatial relation reference signal)
(2) Trigger mobility to a target cell
(3) Update codebook related parameters
(4) Update Doppler related parameters
(5) Update TA
(6) Updated configuration based on other non-beam, non-mobility, non-CSI, non-TDCP, non-time related measurements.

Although FIGS. 7-10 illustrates example process 700-1000 for RS measurement by a UE, various changes may be made to FIGS. 7-10. For example, while shown as a series of steps, various steps in FIGS. 7-10 could overlap, occur in parallel, occur in a different order, or occur any number of times.

FIGS. 11-14 illustrates example processes 1100-1400 for RS measurement by a network according to embodiments of the present disclosure. The embodiments of processes 1100-1400 for RS measurement by a network of FIGS. 11-14 are for illustration only. One or more of the components illustrated in FIGS. 11-14 may be implemented in specialized circuitry configured to perform the noted functions or one or more of the components may be implemented by one or more processors executing instructions to perform the noted functions. Other embodiments of processes 1100-1400 for RS measurement by a network could be used without departing from the scope of this disclosure.

In the Example of FIG. 11, at step 1 a network (e.g., base Station (BS), gNB or transmission/reception point (TRP)) 1102 configures and/or activates and/or triggers a UE 1104 to transmit a reference signal (RS) at block 1106, and UE 1104 receives and applies such configuration and/or activation and/or triggering at block 1108. At step 2, UE 1104 transmits the reference signal (RS) at block 1110, and the gNB 1102 measures the RS at block 1112. At step 3, network 1102 further configures UE 1104 based on the measured reference signal at block 1114, and UE 1104 applies the configuration at block 1116.

In step 2 of FIG. 11, the RS can be:
(1) Sounding Reference Signal (SRS) and/or
(2) a demodulation reference signal (DMRS) associated with a PUSCH and/or PUCCH and/or
(3) a random access preamble.

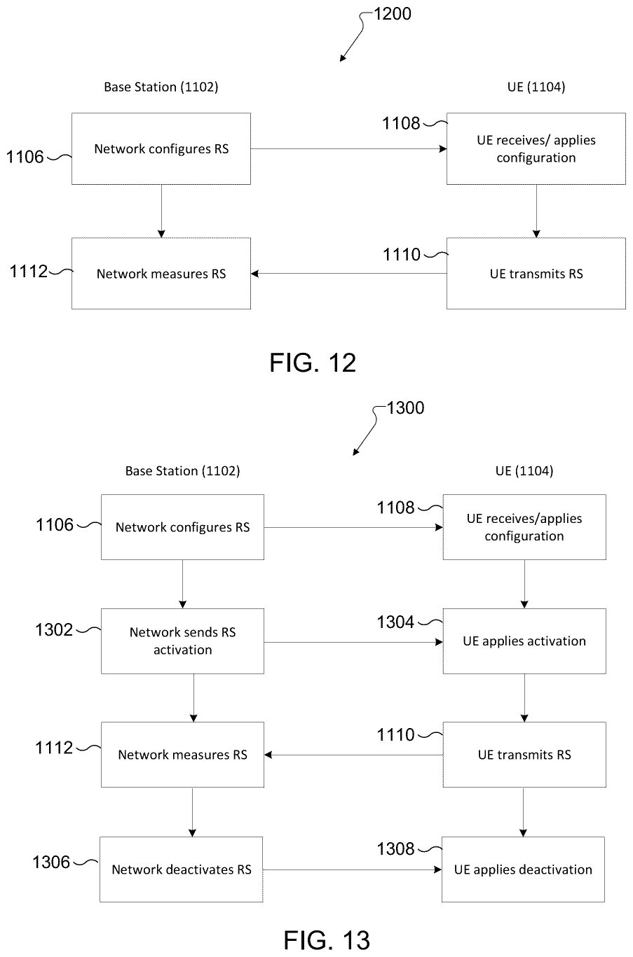

In step 1 and step 2 of FIG. 11, in one embodiment, the RS can be periodically configured RS, similar as illustrated in example 1200 of FIG. 12. In the example of FIG. 12, network 1102 configures the RS (e.g., using higher layer configuration such as RRC configuration) at block 1106, and UE 1104 receives and applies the configuration at block 1108, similar as illustrated in FIG. 11. UE 1104 then transmits the RS based on the configuration at block 1110, and network 1102 measures the RS at block 1112, similar as illustrated in FIG. 11.

In step 1 and step 2 of FIG. 11, in one embodiment, the RS can be semi-persistent RS, similar as illustrated in example 1300 of FIG. 13. In the example of FIG. 13, network 1102 configures the RS (e.g., using higher layer configuration such as RRC configuration) at block 1106, and UE 1104 receives and applies the configuration at block 1108, similar as illustrated in FIG. 11. But The RS is not transmitted by UE 1104 until it is activated at block 1302, and the UE applies the activation at block 1304. For example, activation signaling can be MAC CE signaling and/or L1 control signaling (e.g., DCI signaling). After the RS is activated, the RS is transmitted by UE 1104 (e.g., periodically) at block 1110 and network 1102 measures the RS at block 1112 similar as illustrated in FIG. 11 until the RS is deactivated at block 1306, and UE 1104 applies the deactivation at block 1308. For example, deactivation signaling can be MAC CE signaling and/or L1 control signaling (e.g., DCI signaling). After the RS is deactivated, the RS is not transmitted until further activation.

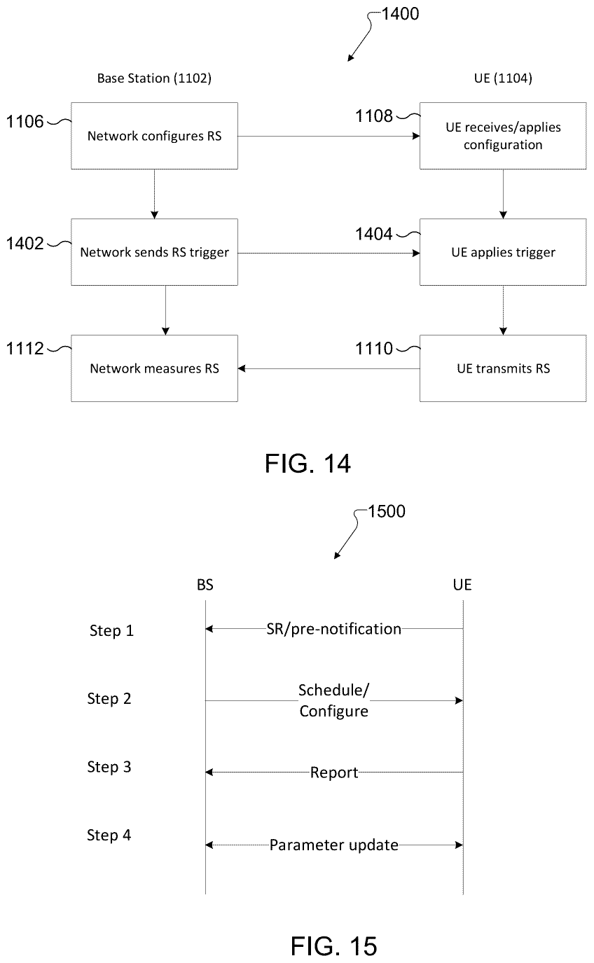

In step 1 and step 2 of FIG. 11, in one embodiment, the RS can be aperiodic RS, similar as illustrated in example 1400 of FIG. 14. In the example of FIG. 14, network 1102 configures the RS (e.g., using higher layer configuration such as RRC configuration) at block 1106, and UE 1104 receives and applies the configuration at block 1108, similar as illustrated in FIG. 11. But the RS is not transmitted until it is triggered at block 1402, and UE 1104 applies the trigger at block 1404. For example, trigger signaling can be L1 control signaling (e.g., DCI signaling) and/or MAC CE signaling. In one example, trigger signaling can trigger one transmission instance of RS. In another example trigger signaling can trigger N transmission instances of RS. Wherein, N can be specified in specifications and/or configured by higher layer signaling (e.g., RRC signaling and/or MAC CE signaling) and/or configured by L1 control signaling (e.g., DCI signaling) and/or included in the message triggering the transmission of the RS. UE 1104 then transmits the RS based on the configuration at block 1110, and network 1102 measures the RS at block 1112, similar as illustrated in FIG. 11.

In step 2 of FIG. 11, the measurement can be:
(1) Beam related measurement (e.g., L1-RSRP measurement and/or L1-SINR measurement).
(2) Mobility (e.g., handover) measurement (e.g., L1-RSRP measurement, L3-RSRP measurement, L1-SINR measurement and/or RSRQ measurement).
(3) Channel state information (CSI) related measurement (e.g., to determine a channel quality and/or precoding matrix and/or a rank for the channel).
(4) Time domain channel properties (TDCP) measurement (e.g., for Doppler profile and/or auto correlation profile.
(5) Time related measurements (e.g., time of arrival difference of RS from UE).
(6) Other non-beam, non-mobility, non-CSI, non-TDCP, non-time related measurements.

In step 3 of FIG. 11, after performing the measurement on the RS transmitted by the UE, the network takes action based on the measurement and the UE applies the indicated action. For example, the action be one of:
(1) Application of a new beam (e.g., TCI state or spatial relation reference signal)
(2) Trigger mobility to a target cell
(3) Update codebook related parameters
(4) Update Doppler related parameters
(5) Update TA
(6) Updated configuration based on other non-beam, non-mobility, non-CSI, non-TDCP, non-time related measurements.

Although FIG. 11 illustrates an example process 1100 for RS measurement by a network, various changes may be made to FIG. 11. For example, while shown as a series of steps, various steps in FIG. 11 could overlap, occur in parallel, occur in a different order, or occur any number of times.

Based on the previous description, the network can configure and/or activate and/or trigger the reference signal (RS) that is transmitted by the network and measured by the UE or the RS that is transmitted by the UE and measured by the network. The network can also configure and/or activate and/or trigger the channel used to report the measurement performed by the UE to the network. In some cases, such operation can lead to additionally latency, as the UE has to wait for the network to configure and/or activate and/or trigger the RS and/or channel for reporting the measurement. In some cases, such operation can be lead to additional overhead as resources are being configured for the measurement RS and/or channel for reporting measurement, when the report has not changed between consecutive instances of reporting leading to inefficient utilization of air interface resources.

To mitigate, the previously mentioned, latency and/or overhead issues, UE initiated measurement and reporting is considered. A procedure for UE initiated measurement and/or reporting is as illustrated in FIG. 15.

FIG. 15 illustrates an example procedure 1500 for UE initiated measurement and/or reporting according to embodiments of the present disclosure. The embodiment of procedure 1500 for UE initiated measurement and/or reporting of FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a procedure 1500 for UE initiated measurement and/or reporting could be used without departing from the scope of this disclosure.

In the example of FIG. 15, in step 1, a UE sends a pre-notification or request signal to a gNB. The pre-notification message or request message can be sent in anticipation of the report or as the report is being prepared In step 2, the network responds with a signal providing resources and configuration for transmission of a report that includes measurements performed by the UE. In step 3, the UE provides a report. In some embodiments, the network can acknowledge the reception of the report. In step 4, the UE and/or the base station apples or updates a parameter based on the report. In some embodiments, the timing of the application of the report is aligned at the UE and the base station.

In some embodiments, one or more of the aforementioned steps can be omitted.

In one example, step 1 is omitted, and the base station (gNB) configures and/or activates and/or triggers a report from the UE. In one example, RRC configuration can configured and allocate resources for the UE. In one example, a MAC CE (and/or L1 control signaling (e.g., DCI) can activate reporting from the UE. In another example, L1 control signaling (e.g., DCI) (and/or MAC CE signaling) can trigger reporting from the UE (e.g., trigger a pre-configured report, or include a UL grant). The condition to trigger the report can be established by the network (e.g., based on channel conditions and/or BLER and/or other measurements the gNB might have acquired based on its own measurements and/or measurements of another gNB/base station/TRP and/or measurements from a UE). The configuration/activation/triggering of a report can also include or be associated with configuration/activation/triggering of RS that can be used for measurement.

In one example, step 1 and step 2 are omitted, and the UE provides the report without triggering and/or activation by the network and without pre-notification to the network. The network can still configure resources to be used by the UE for such reporting (for example, PUSCH and/or PUCCH and/or RACH resources). In one example, multiple report configurations are configured, wherein a UE can select a report configuration based on the report payload size and/or the report type.

In one example, step 2 is omitted, and the UE provides the network per-notification that it would transmit the report and transmits the report without getting activation or triggering from the network. The network can still configure resources to be used by the UE for such reporting (for example, PUSCH and/or PUCCH and/or RACH resources). The network can also configure resources to use for pre-notification.

In one example, step 2 and step 3 are omitted. For example, the SR or pre-notification (step 1) can provide an indication from the UE to the network for the network to perform a certain action. Such action can be for example to perform a beam switch or to perform mobility (e.g., handover) to a target cell. The network can configure resources to use for pre-notification

In one example, after step 3, the network acknowledges reception of a message or report from the UE. The UE and network can update one or more parameters, based on the report, after a time T, or within a time T, or after a time T (for example, first symbol or slot or sub-frame or frame boundary at or after a time T) from the report or from the acknowledgement.

In one example, after step 3, the UE and network can update one or more parameters, based on the report, at a time T, or within a time T, or after a time T (for example, first symbol or slot or sub-frame or frame boundary at or after a time T) from the report.

In step 3 of FIG. 15, the report can be one of:
(1) a one part or one stage report.
(2) a two part or two stage report.

In this disclosure a UE initiates a reporting (e.g., step 1 or step 3 of FIG. 15) based on a metric M. For example, the metric M can be one of the following examples (other examples are also possible):
The block error rate.
The L1-RSRP and/or L1-SINR and/or L3-RSRP and/or RSRQ of an indicated TCI state
The L1-RSRP and/or L1-SINR and/or L3-RSRP and/or RSRQ of an activated TCI state that is not indicated
The L1-RSRP and/or L1-SINR and/or L3-RSRP and/or RSRQ of TCI state that is not indicated
The L1-RSRP and/or L1-SINR and/or L3-RSRP and/or RSRQ of reference signal
The L1-RSRP and/or L1-SINR and/or L3-RSRP and/or RSRQ of reference signal not associated with an indicated TCI state
The L1-RSRP and/or L1-SINR and/or L3-RSRP and/or RSRQ of TCI state associated with a non-serving cell (e.g., candidate cell or target cell)
The L1-RSRP and/or L1-SINR and/or L3-RSRP and/or RSRQ of a non-serving cell (e.g., candidate cell or target cell).
Difference in time of arrival between an RS and a reference RS. For example, the reference RS can be that of a serving cell or a TRP of a serving cell.
CQI metric.
Difference in CQI metric between measured CQI and (e.g., last) reported CQI.
PMI metric.
Difference in PMI between measured PMI and (e.g., last) reported PMI.
RI metric.
Difference in rank between last measured rank and (e.g., last) reported rank.
Difference in TDCP between measured TDCP and (e.g., last) reported TDCP.
Doppler shift.
Doppler spread.
Difference in Doppler shift between measured Doppler shift and Doppler shift associated with (e.g., last) report.
Difference in Doppler spread between measured Doppler spread and Doppler spread associated with (e.g., last) report

A UE can have a threshold T, wherein, T can be specified in system specification (e.g., in one example T=0) and/or configured and/or updated by RRC signaling and/or MAC CE signaling and/or L1 control (e.g., DCI) signaling. In one example, a report is initiated by the UE if:
M>T
M≥T
M<T
M≤T
M=T
M≠T

A UE can have a first threshold T₁ and a second threshold T₂. Wherein, T₁<T₂, and wherein, T₁ and/or T₂ can be specified in system specification and/or configured and/or updated by RRC signaling and/or MAC CE signaling and/or L1 control (e.g., DCI) signaling. In one example T₁=−T₂. In one example report is initiated by the UE if one of the following is satisfied:
T₁<M<T₂
T₁≤M<T₂
T₁<M≤T₂
T₁≤M≤T₂
T₁>M or T₂<M
T₁≥M or T₂<M
T₁>M or T₂≤M
T₁≥M or T₂≤M

Although FIG. 15 illustrates an example procedure 1500 for UE initiated measurement and/or reporting, various changes may be made to FIG. 15. For example, while shown as a series of steps, various steps in FIG. 15 could overlap, occur in parallel, occur in a different order, or occur any number of times.

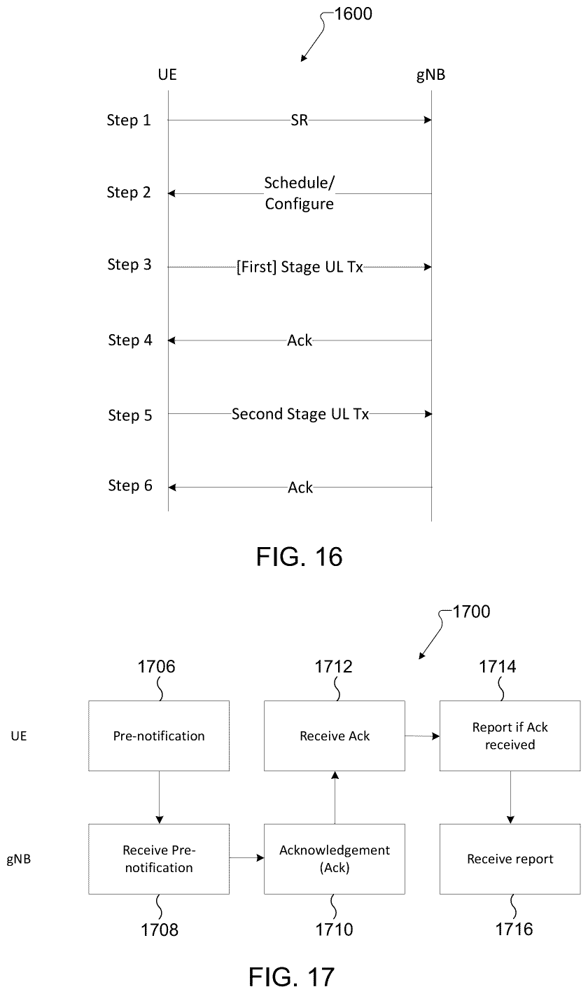

In some embodiments, the network can acknowledge the transmissions from the UE similar as illustrated in FIG. 16.

FIG. 16 illustrates an example 1600 of a signaling exchange between a network and a UE according to embodiments of the present disclosure. The embodiment of the signaling exchange of FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a signaling exchange between a network and a UE could be used without departing from the scope of this disclosure.

In the example of FIG. 16, in step 1, a UE sends a request signal to a gNB. In step 2, the network responds with a signal providing resources and configuration for transmission by the UE (e.g., DCI or MAC CE). In step 3, UE performs an UL transmission. This may be a first stage of a multistage transmission. At step 4, the network acknowledges the transmission. In step 5, the UE a performs a second stage of an UL transmission. At step 6, the network acknowledges the transmission.

In some embodiments, some of these steps might be omitted (e.g., the second stage UL Tx and associated Ack can be omitted).

Although FIG. 16 illustrates an example 1600 of a signaling exchange between a network and a UE, various changes may be made to FIG. 16. For example, while shown as a series of steps, various steps in FIG. 16 could overlap, occur in parallel, occur in a different order, or occur any number of times.

In one embodiment, the UE can send a signal to the gNB/TRP/network, wherein the signal can be a scheduling request for the gNB/TRP/network to allocated/schedule UL resources for the transmission of the report from the UE. In this scenario, the response of the gNB/TRP/network to the scheduling request, by allocating/scheduling UL resources, can be considered as an acknowledgement for the scheduling request.

In one embodiment, after sending the scheduling request if the UE doesn't receive the acknowledgment (e.g., channel/signal allocating/scheduling UL resources for report from UE), the UE can retransmit a scheduling request.

In one embodiment, after sending the scheduling request, the UE expects the acknowledgment (e.g., channel/signal allocating/scheduling UL resources for report from UE) at time T, or after a time T (for example, first symbol or slot or sub-frame or frame boundary at or after a time T) from scheduling request. In one example, T is from the start of the signal/channel with the scheduling request. In one example, T is from the end of the signal/channel with the scheduling request. In one example T, is to the start of the signal/channel with acknowledgment to the UE. In one example T, is to the end of the signal/channel with acknowledgment to the UE. In one example T, is to the start of the slot containing the signal/channel with acknowledgment to the UE. In one example T, is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example T, depends on the sub-carrier spacing of the signal/channel of the scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment (e.g., channel/signal allocating/scheduling UL resources for report from UE) at time T as aforementioned, the UE can retransmit the scheduling request.

In one embodiment, after sending the scheduling request, the UE expects the acknowledgment (e.g., channel/signal allocating/scheduling UL resources for report from UE) before time T (or before or at time T) from scheduling request. In one example, T is from the start of the signal/channel with the scheduling request. In one example, T is from the end of the signal/channel with the scheduling request. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment (e.g., channel/signal allocating/scheduling UL resources for report from UE) before time T (or before or at time T) as aforementioned, the UE can retransmit the scheduling request.

In one embodiment, after sending the scheduling request, the UE expects the acknowledgment (e.g., channel/signal allocating/scheduling UL resources for report from UE) at time t, or after a time t (for example, first symbol or slot or sub-frame or frame boundary at or after a time t) from scheduling request, such that one of (1) T1<t<T2, or (2) T1≤t≤T2 or (3) T1<t≤T2 or (4) T1≤t<T2. In one example, T1 and/or T2 is/are from the start of the signal/channel with the scheduling request. In one example, T1 and/or T2 is/are from the end of the signal/channel with the scheduling request. In one example, T1 and/or T2 is/are to the start of the signal/channel with acknowledgment to the UE. In one example, T1 and/or T2 is/are to the end of the signal/channel with acknowledgment to the UE. In one example, T1 and/or T2 is/are to the start of the slot containing the signal/channel with acknowledgment to the UE. In one example, T1 and/or T2 is/are to the end of the slot containing the signal/channel with acknowledgement to the UE. In one example, T1 and/or T2 is/are specified by system specifications and/or configured or updated by RRC signaling and/or MAC CE signaling and/or L1 control (e.g., DCI) signaling. In one example T1 and/or T2 depends on the sub-carrier spacing of the signal/channel of the scheduling request and/or signal/channel with acknowledgement to the UE and/or channel of report from UE. In one example, T1 and/or T2 depends on a UE capability. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, if the UE doesn't receive an acknowledgment (e.g., channel/signal allocating/scheduling UL resources for report from UE) at time t, the UE can retransmit the scheduling request, such that one of (1) T1<t<T2, or (2) T1≤t≤T2 or (3) T1<t≤T2 or (4) T1≤t<T2. In one example, T1 and/or T2 can be in units of symbols.

In one embodiment, after sending a first scheduling request if the UE doesn't receive the acknowledgment (e.g., channel/signal allocating/scheduling UL resources for report from UE), the UE can transmit a second scheduling request after time T (or at or after time T, or at time T). In one example, T is from the start of the signal/channel with the first scheduling request. In one example, T is from the end of the signal/channel with the first scheduling request. In one example T, is from the start of the signal/channel with acknowledgment to the UE of the first scheduling request (e.g., this can be based on the latest expected acknowledgement to the first scheduling request). In one example T, is from the end of the signal/channel with acknowledgment to the UE of the first scheduling request (e.g., this can be based on the latest expected acknowledgement to the first scheduling request). In one example, T is specified by system specifications and/or configured or updated by RRC signaling and/or MAC CE signaling and/or L1 control (e.g., DCI) signaling. In one example, T depends on the sub-carrier spacing of the signal/channel of the scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, the acknowledgement to the scheduling request can be a channel/signal that is separate from the channel/signal allocating/scheduling UL resources for report from UE. For example, the acknowledgement can be a DCI Format acknowledging the reception of the scheduling request.

In one embodiment, the scheduling request is semi-persistent, wherein the UE sends the scheduling request with a periodicity P and until a time T expires or for N instances. The gNB/TRP/network can acknowledge the scheduling requesting (e.g., by sending a channel/signal allocating/scheduling UL resources for report from UE). In one example, T and/or P and/or N can be specified by system specifications and/or configured or updated by RRC signaling and/or MAC CE signaling and/or L1 control (e.g., DCI) signaling.

In one embodiment, the scheduling request is semi-persistent, wherein the UE sends the scheduling request with a periodicity P and until one of the following events occurs: (1) a time T expires and/or for N instances (2) the UE receives an acknowledgement from the gNB/TRP/network (e.g., by receiving a channel/signal allocating/scheduling UL resources for report from UE). In one example, T and/or P and/or N can be specified by system specifications and/or configured or updated by RRC signaling and/or MAC CE signaling and/or L1 control (e.g., DCI) signaling.

In one embodiment, the UE can send a channel/signal to the gNB/TRP/network, wherein the channel/signal can be a pre-notification channel/signal. The pre-notification channel/signal is for an UL transmission that includes a report from the UE. The network acknowledges the pre-notification channel/signal. After the UE receives the acknowledgment, the UE transmits the report. This is illustrated in FIG. 17.

FIG. 17 illustrates an example 1700 of a UE sending a pre-notification channel/signal to a network according to embodiments of the present disclosure. The embodiment of a UE sending a pre-notification channel/signal to a network of FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of a UE sending a pre-notification channel/signal to a network could be used without departing from the scope of this disclosure.

In the example of FIG. 17, a UE sends a pre-notification channel/signal is for an UL transmission that includes a report from the UE to a gNB at block 1706. At block 1708, the gNB receives the pre-notification and sends an acknowledgement to the UE at block 1710. In one example, the acknowledgement includes resource allocation information e.g., UL grant for report. In one example, the acknowledgement is for pre-configured resources. At block 1712, the UE receives the acknowledgement, and sends the report to the gNB at block 1714. At block 1716 the gNB receives the report.

Although FIG. 17 illustrates an example 1700 of a UE sending a pre-notification channel/signal to a network, various changes may be made to FIG. 17. For example, while shown as a series of steps, various steps in FIG. 17 could overlap, occur in parallel, occur in a different order, or occur any number of times.

In one embodiment, after sending the pre-notification channel/signal, if the UE doesn't receive an acknowledgement, the UE can re-transmit a pre-notification channel/signal.

In one embodiment, after sending the pre-notification channel/signal, the UE expects an acknowledgment at time T, or after a time T (for example, first symbol or slot or sub-frame or frame boundary at or after a time T) from the pre-notification channel/signal. In one example, Tis from the start of the signal/channel with the pre-notification channel/signal. In one example T, is from the end of the signal/channel with the pre-notification channel/signal. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the pre-notification channel/signal and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment at time T, as aforementioned, the UE can retransmit the pre-notification channel/signal. In one example, if the UE receives an acknowledgment at time T, as aforementioned, the UE can transmit a report.

In one embodiment, after sending the pre-notification channel/signal, the UE expects an acknowledgment before time T (or before or at time T) from the pre-notification channel/signal. In one example, T is from the start of the signal/channel with the pre-notification channel/signal. In one example, T is from the end of the signal/channel with the pre-notification channel/signal. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the pre-notification channel/signal and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment before time T (or before or at time T), as aforementioned, the UE can retransmit the pre-notification channel/signal. In one example, if the UE receives an acknowledgment before time T (or before or at time T), as aforementioned, the UE transmits a report.

In one embodiment, after sending the pre-notification channel/signal, the UE expects an acknowledgment at time t, or after a time t (for example, first symbol or slot or sub-frame or frame boundary at or after a time t) from the pre-notification channel/signal, such that one of (1) T1<t<T2, or (2) T1≤ t≤T2 or (3) T1<t≤T2 or (4) T1≤t<T2. In one example, T1 and/or T2 is from the start of the signal/channel with the pre-notification channel/signal. In one example, T1 and/or T2 is from the end of the signal/channel with the pre-notification channel/signal. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot containing the signal/channel with acknowledgment to the UE. In one example T1 and/or T2 is to the end of the slot containing the signal/channel with acknowledgement to the UE. In one example, T1 and/or T2 is specified by system specifications and/or configured or updated by RRC signaling and/or MAC CE signaling and/or L1 control (e.g., DCI) signaling. In one example, T1 and/or T2 depends on the sub-carrier spacing of the signal/channel of the pre-notification channel/signal and/or signal/channel with acknowledgement to the UE and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, if the UE doesn't receive an acknowledgment at time t, the UE can retransmit the pre-notification channel/signal, such that one of (1) T1<t<T2, or (2) T1≤t≤T2 or (3) T1<t≤T2 or (4) T1≤t<T2. In one example, if the UE receives an acknowledgment at time t, as aforementioned, the UE can transmit a report.

In one embodiment, after sending the pre-notification channel/signal, and after receiving an acknowledgement, the UE can transmit a report.

In one embodiment, after sending the pre-notification channel/signal, and after receiving an acknowledgement, the UE transmits a report at time t, or after a time t (for example, first symbol or slot or sub-frame or frame boundary at or after a time t). In one example, time t is a duration T from the start of the signal/channel with the pre-notification channel/signal. In one example, time t is a duration T from the end of the signal/channel with the pre-notification channel/signal. In one example, time t is a duration T from the start of the signal/channel with the acknowledgment to the UE. In one example, time t is a duration T from the end of the signal/channel with the acknowledgment to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the pre-notification channel/signal and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, after sending the pre-notification channel/signal, and after receiving an acknowledgement, the UE transmits a report at time t, or after a time t (for example, first symbol or slot or sub-frame or frame boundary at or after a time t). In one example, time t is between a duration T1 (inclusive or exclusive) and a duration T2 (inclusive or exclusive) from the start of the signal/channel with the pre-notification channel/signal. In one example, time t is between a duration T1 (inclusive or exclusive) and a duration T2 (inclusive or exclusive) from the end of the signal/channel with the pre-notification channel/signal. In one example, time t is between a duration T1 (inclusive or exclusive) and a duration T2 (inclusive or exclusive) from the start of the signal/channel with the acknowledgment to the UE. In one example, time t is between a duration T1 (inclusive or exclusive) and a duration T2 (inclusive or exclusive) from the end of the signal/channel with the acknowledgment to the UE. In one example, T1 and/or T2 is specified by system specifications and/or configured or updated by RRC signaling and/or MAC CE signaling and/or L1 control (e.g., DCI) signaling. In one example, T1 and/or T2 depends on the sub-carrier spacing of the signal/channel of the pre-notification channel/signal and/or signal/channel with acknowledgement to the UE and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, T1 can be zero. In one example, T2 can be infinity.

In one embodiment, after sending a first pre-notification channel/signal if the UE doesn't receive the acknowledgment, the UE can transmit a second pre-notification channel/signal after time T (or at or after time T, or at time T). In one example, T is from the start of the first pre-notification channel/signal. In one example, T is from the end of the first pre-notification channel/signal. In one example T, is from the start of the signal/channel with acknowledgment to the UE of the first pre-notification channel/signal (e.g., this can be based on the latest expected acknowledgement to the first pre-notification channel/signal). In one example T, is from the end of the signal/channel with acknowledgment to the UE of the first pre-notification channel/signal (e.g., this can be based on the latest expected acknowledgement to the first pre-notification channel/signal). In one example, T is specified by system specifications and/or configured or updated by RRC signaling and/or MAC CE signaling and/or L1 control (e.g., DCI) signaling. In one example, T depends on the sub-carrier spacing of the signal/channel of the pre-notification channel/signal or scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, the acknowledgement to the pre-notification channel/signal can be a DCI Format acknowledging the reception of the pre-notification channel/signal.

In one embodiment, the pre-notification signal/channel is semi-persistent, wherein the UE sends the pre-notification signal/channel with a periodicity P and until a time T expires and/or for N instances. The gNB/TRP/network can acknowledge the pre-notification signal/channel. In one example, T and/or P and/or N can be specified by system specifications and/or configured or updated by RRC signaling and/or MAC CE signaling and/or L1 control (e.g., DCI) signaling.

In one embodiment, the pre-notification signal/channel is semi-persistent, wherein the UE sends the pre-notification signal/channel with a periodicity P and until one of the following events occurs: (1) a time T expires and/or for N instances (2) the UE receives an acknowledgement from the gNB/TRP/network. In one example, T and/or P and/or N can be specified by system specifications and/or configured or updated by RRC signaling and/or MAC CE signaling and/or L1 control (e.g., DCI) signaling.

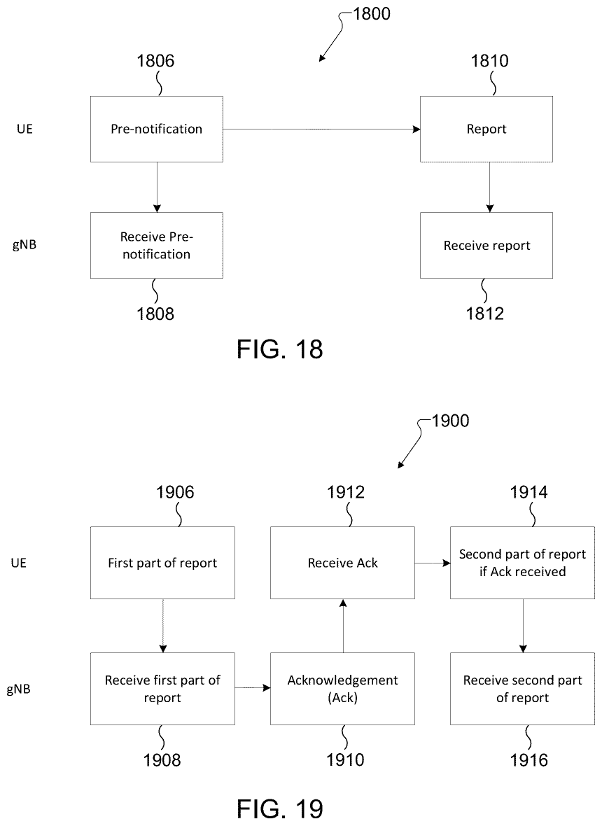

In one embodiment, the UE can send a signal to the gNB/TRP/network, wherein the signal can be a pre-notification channel/signal. The pre-notification channel/signal is for an UL transmission that includes a report from the UE. There is no acknowledgment for the pre-notification channel/signal. The UE sends the report after sending the pre-notification channel/signal. This is illustrated in FIG. 18.

FIG. 18 illustrates an example 1800 of a UE sending a pre-notification channel/signal to a network without receiving an acknowledgment according to embodiments of the present disclosure. The embodiment of a UE sending a pre-notification channel/signal to a network of FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of a UE sending a pre-notification channel/signal to a network without receiving an acknowledgement could be used without departing from the scope of this disclosure.

In the example of FIG. 18, a UE sends a pre-notification channel/signal is for an UL transmission that includes a report from the UE to a gNB at block 1806. At block 1808, the gNB receives the pre-notification. At block 1810, the UE sends the report to the gNB. At block 1812 the gNB receives the report.

Although FIG. 18 illustrates an example 1800 of a UE sending a pre-notification channel/signal to a network without receiving an acknowledgment, various changes may be made to FIG. 18. For example, while shown as a series of steps, various steps in FIG. 18 could overlap, occur in parallel, occur in a different order, or occur any number of times.

In one embodiment, after sending the pre-notification channel/signal, the UE transmits a report at time t, or within time t, or after a time t (for example, first symbol or slot or sub-frame or frame boundary at or after a time t). In one example, time t is a duration T from the start of the signal/channel with the pre-notification channel/signal. In one example, time t is a duration T from the end of the signal/channel with the pre-notification channel/signal. In one example, T is specified by system specifications and/or configured or updated by RRC signaling and/or MAC CE signaling and/or L1 control (e.g., DCI) signaling. In one example, T depends on the sub-carrier spacing of the signal/channel of the pre-notification channel/signal and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, after sending the pre-notification channel/signal, the UE transmits a report at time t, or after a time T (for example, first symbol or slot or sub-frame or frame boundary at or after a time T). In one example, time t is between a duration T1 (inclusive or exclusive) and a duration T2 (inclusive or exclusive) from the start of the signal/channel with the pre-notification channel/signal. In one example, time t is between a duration T1 (inclusive or exclusive) and a duration T2 (inclusive or exclusive) from the end of the signal/channel with the pre-notification channel/signal. In one example, T1 and/or T2 is specified by system specifications and/or configured or updated by RRC signaling and/or MAC CE signaling and/or L1 control (e.g., DCI) signaling. In one example T1 and/or T2, depends on the sub-carrier spacing of the signal/channel of the pre-notification channel/signal and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, T1 can be zero. In one example, T2 can be infinity.

In one embodiment, the gNB/TRP/network can send signal/channel to the UE to configure or schedule an UL transmission from the UE that includes a report.

In one embodiment, the signal/channel from the gNB/TRP/network to configure/schedule an UL transmission that includes a report from a UE is in response to a scheduling request (SR) from the UE.

In one embodiment, after receiving a scheduling request from a UE, the gNB/TRP/network transmits a channel/signal allocating/scheduling UL resources for report from UE at time T, or after a time T (for example, first symbol or slot or sub-frame or frame boundary at or after a time T) from the scheduling request. In one example, T is from the start of the signal/channel with the scheduling request. In one example, T is from the end of the signal/channel with the scheduling request. In one example T, is to the start of the signal/channel allocating/scheduling UL resources for report from UE. In one example T, is to the end of the signal/channel allocating/scheduling UL resources for report from UE. In one example T, is to the start of the slot containing the signal/channel allocating/scheduling UL resources for report from UE. In one example T, is to the end of the slot containing the signal/channel allocating/scheduling UL resources for report from UE. In one example, T is specified by system specifications and/or configured or updated by RRC signaling and/or MAC CE signaling and/or L1 control (e.g., DCI) signaling. In one example T, depends on the sub-carrier spacing of the signal/channel of the scheduling request and/or signal/channel allocating/scheduling UL resources for report from UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment after receiving a scheduling request from a UE, the gNB/TRP/network transmits a channel/signal allocating/scheduling UL resources for report from UE before time T (or before or at time T) from the scheduling request. In one example, T is from the start of the signal/channel with the scheduling request. In one example, T is from the end of the signal/channel with the scheduling request. In one example, T is to the start of the signal/channel allocating/scheduling UL resources for report from UE. In one example, T is to the end of the signal/channel allocating/scheduling UL resources for report from UE. In one example, T is to the start of the slot containing the signal/channel allocating/scheduling UL resources for report from UE. In one example, T is to the end of the slot containing the signal/channel allocating/scheduling UL resources for report from UE. In one example, T is specified by system specifications and/or configured or updated by RRC signaling and/or MAC CE signaling and/or L1 control (e.g., DCI) signaling. In one example, T depends on the sub-carrier spacing of the signal/channel of the scheduling request and/or signal/channel allocating/scheduling UL resources for report from UE and/or channel of report from UE. In one example, T depends on a UE capability. In one example, T can be in units of symbols.

In one embodiment, after receiving a scheduling request from a UE, the gNB/TRP/network transmits a channel/signal allocating/scheduling UL resources for report from UE at time t, or after a time t (for example, first symbol or slot or sub-frame or frame boundary at or after a time t) from the scheduling request, such that one of (1) T1<t<T2, or (2) T1≤t≤T2 or (3) T1<t≤T2 or (4) T1≤t<T2. In one example, T1 and/or T2 is/are from the start of the signal/channel with the scheduling request. In one example, T1 and/or T2 is/are from the end of the signal/channel with the scheduling request. In one example, T1 and/or T2 is/are to the start of the signal/channel allocating/scheduling UL resources for report from UE. In one example, T1 and/or T2 is/are to the end of the signal/channel allocating/scheduling UL resources for report from UE. In one example, T1 and/or T2 is/are to the start of the slot containing the signal/channel allocating/scheduling UL resources for report from UE. In one example, T1 and/or T2 is/are to the end of the slot containing the signal/channel allocating/scheduling UL resources for report from UE. In one example, T1 and/or T2 is specified by system specifications and/or configured or updated by RRC signaling and/or MAC CE signaling and/or L1 control (e.g., DCI) signaling. In one example T1 and/or T2 depends on the sub-carrier spacing of the signal/channel of the scheduling request and/or signal/channel allocating/scheduling UL resources for report from UE and/or channel of report from UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.).

In one embodiment, the signal/channel from the gNB/TRP/network to configure/schedule an UL transmission that includes a report from a UE is autonomously generated by the gNB/TRP/network.

In one embodiment, a UE can send a report to the gNB/TRP/Network on uplink resources. The report can comprise one part or one stage.

In one embodiment, the UE can send a report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent in response to a scheduling request from the UE. In one example, multiple report configurations are configured, wherein a UE can select or indicate a configuration based on the report payload size and/or the report type.

In one embodiment, the UE can send a report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent autonomously from the gNB/TRP/Network.

In one embodiment, the UE can send a report to the gNB/TRP/Network on uplink resources based on a pre-notification channel/signal from UE and after an acknowledgment of the pre-notification channel/signal is received from the gNB/TRP/Network.

In one embodiment, the UE can send a report to the gNB/TRP/Network on uplink resources based on a pre-notification channel/signal from UE. The notification channel/signal may not be acknowledged from the gNB/TRP/Network.

In one embodiment, the UE can send a report to the gNB/TRP/Network on uplink resources without sending a scheduling request or a pre-notification channel/signal and without receiving a channel/signal, from gNB/TRP/Network, allocating/scheduling UL resources for the report from the UE.

In one embodiment, the UE can send a report in UL resources to the gNB/TRP/Network. If the gNB/TRP/Network receives the UE report, the gNB/TRP/Network can acknowledge UE report.

In one embodiment, after sending the report, if the UE doesn't receive an acknowledgement, the UE can re-transmit the UE report or transmit a new UE report.

In one embodiment, after sending the report, the UE expects an acknowledgment at time T, or after a time T (for example, first symbol or slot or sub-frame or frame boundary at or after a time T) from the report. In one example, T is from the start of the signal/channel that includes the report. In one example T, is from the end of the signal/channel that includes the report. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel that includes the report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment at time T, as aforementioned, the UE can retransmit the report or a new report. In one example, if the UE receives an acknowledgment at time T, as aforementioned, the UE can update a parameter based on the report as described later in this disclosure.

In one embodiment, after sending the report, the UE expects an acknowledgment before time T (or before or at time T) from the report. In one example, T is from the start of the signal/channel that includes the report. In one example, T is from the end of the signal/channel that includes the report. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel that includes the report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment before time T (or before or at time T), as aforementioned, the UE can retransmit the report or a new report. In one example, if the UE receives an acknowledgment before time T (or before or at time T), as aforementioned, the UE can update a parameter based on the report as described later in this disclosure.

In one embodiment after sending the report, the UE expects an acknowledgment at time t, or after a time t (for example, first symbol or slot or sub-frame or frame boundary at or after a time t) from the report, such that one of (1) T1<t<T2, or (2) T1≤t<T2 or (3) T1<<<T2 or (4) T1≤t<T2. In one example, T1 and/or T2 is from the start of the signal/channel that includes the report. In one example, T1 and/or T2 is from the end of the signal/channel that includes the report. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot containing the signal/channel with acknowledgment to the UE. In one example T1 and/or T2 is to the end of the slot containing the signal/channel with acknowledgement to the UE. In one example, T1 and/or T2 is specified by system specifications and/or configured or updated by RRC signaling and/or MAC CE signaling and/or L1 control (e.g., DCI) signaling. In one example, T1 and/or T2 depends on the sub-carrier spacing of the signal/channel that includes the report and/or signal/channel with acknowledgement to the UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, if the UE doesn't receive an acknowledgment at time t, the UE can retransmit the report or a new report, such that one of (1) T1<t<T2, or (2) T1≤t≤T2 or (3) T1<t≤T2 or (4) T1≤t<T2. If the UE receives an acknowledgment at time t, as aforementioned, the UE can update a parameter based on the report as described later in this disclosure.

In one embodiment, after sending a first report if the UE doesn't receive the acknowledgement, the UE can transmit a second report after time T (or at or after time T, or at time T), e.g., the second report can be a re-transmission of the first report or a new report. In one example, T is from the start of the signal/channel that includes the first report. In one example, T is from the end of the signal/channel with that includes the first report. In one example T, is from the start of the signal/channel with acknowledgment to the UE of the first report (e.g., this can be based on the latest expected acknowledgement to the first report). In one example T, is from the end of the signal/channel with acknowledgment to the UE of the first report (e.g., this can be based on the latest expected acknowledgement to the first report). In one example, T is specified by system specifications and/or configured or updated by RRC signaling and/or MAC CE signaling and/or L1 control (e.g., DCI) signaling. In one example, T depends on the sub-carrier spacing of the signal/channel of the scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, the acknowledgement to the report from the UE can be a DCI Format acknowledging the reception of the report from the UE.

In one embodiment, there is no acknowledgement to the report from the UE.

In one embodiment, the report from the UE is semi-persistent, wherein the UE sends the report with a periodicity P and until a time T expires and/or for N instances. The gNB/TRP/network can acknowledge the UE report. In one example, T and/or P and/or N can be specified by system specifications and/or configured or updated by RRC signaling and/or MAC CE signaling and/or L1 control (e.g., DCI) signaling.

In one embodiment, the report from the UE is semi-persistent, wherein the UE sends the report with a periodicity P and until one of the following events occurs: (1) a time T expires and/or for N instances (2) the UE receives an acknowledgement from the gNB/TRP/network. In one example, T and/or P and/or N can be specified by system specifications and/or configured or updated by RRC signaling and/or MAC CE signaling and/or L1 control (e.g., DCI) signaling.

In one embodiment, a UE can send a report to the gNB/TRP/Network on uplink resources. The report can comprise two parts or two stages. The two parts or stages can be transmitted in the same slot (similar to two-part CSI/UCI reporting). In one embodiment, the two parts or stages can be transmitted in two different slots. In one embodiment, the two parts or stages can be transmitted in the same slot (similar to two-part CSI/UCI reporting) or in two different slots, e.g., depending on the UL resources allocated for the report. In one example, multiple report configurations are configured, wherein a UE can select or indicate a configuration based on the report payload size and/or the report type. In one example, the first stage/part and the second stage/part are transmitted in a same UL channel. In one example, the first stage/part and the second stage/part are transmitted in a first UL channel and a second UL channel respectively.

In one embodiment, the UE can send a two-stage report or two-part report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent in response to a scheduling request from the UE.

In one embodiment, the UE can send a two-stage report or two-part report to the gNB/TRP/Network on uplink resources based on a channel/signal, from gNB/TRP/Network, allocating/scheduling UL resources for a report from the UE. The channel/signal, from gNB/TRP/Network, allocating/scheduling UL resources for a report from the UE can be sent autonomously from the gNB/TRP/Network.

In one embodiment, the UE can send a two-stage report or two-part report to the gNB/TRP/Network on uplink resources based on a pre-notification channel/signal from UE and after an acknowledgment of the pre-notification channel/signal is received from the gNB/TRP/Network.

In one embodiment, the UE can send a two-stage report or two-part report to the gNB/TRP/Network on uplink resources based on a pre-notification channel/signal from UE. The notification channel/signal may not be acknowledged from the gNB/TRP/Network.

In one embodiment, the UE can send a two-stage report or two-part report to the gNB/TRP/Network on uplink resources without sending a scheduling request or a pre-notification channel/signal and without receiving a channel/signal, from gNB/TRP/Network, allocating/scheduling UL resources for the report from the UE.

In one embodiment, the report from the UE can be a one-part report (e.g., single stage) or a two-part report (e.g., with two-parts or two stages). Whether to have one-part or two-parts can depend on a condition. The condition can be based on one or more of the following:
An amount of UL resources. If there are sufficient uplink resources, two-part UE report is used, else a one-part UE report is used. The threshold to switch between a two-part UE report and a one-part UE can be specified by system specifications and/or configured or updated by RRC signaling and/or MAC CE signaling and/or L1 control (e.g., DCI) signaling.
A report type. For example, some report types can be one-part, while other report types can be two-part. This can be based on system specifications and/or configuration or update by RRC signaling and/or MAC CE signaling and/or L1 control (e.g., DCI) signaling. For example, a beam report or a WB CSI report can be configured as one-part report, while a SSB-CSI report can be configured as a two-part report.
A payload size of report. If the payload size is larger than or (larger than or equal to) a threshold two-part report is used, else one-part report is used. The payload size threshold to switch between a two-part UE report and a one-part UE can be specified by system specifications and/or configured or updated by RRC signaling and/or MAC CE signaling and/or L1 control (e.g., DCI) signaling.
The UE's implementation.

In one embodiment, a flag or indication in the first stage/part can indicate whether or not there is a second stage/part.

In one embodiment, it can be determined implicitly based on information in the first stage/part whether or not there is a second stage/part (e.g., based on report type and/or report size).

In one embodiment, the UE can send a channel/signal to the gNB/TRP/network, wherein the channel/signal can be a first stage or a first part report from the UE. The network acknowledges the first stage or the first part report from the UE. After the UE receives the acknowledgment, the UE transmits a second stage or a second part report. This is illustrated in FIG. 19.

FIG. 19 illustrates an example 1900 of a UE sending a first stage/part and a second stage/part of a report to a network according to embodiments of the present disclosure. The embodiment of a UE sending a first stage/part and a second stage/part of a report to a network of FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a UE sending a first stage/part and a second stage/part of a report to a network could be used without departing from the scope of this disclosure.

In the example of FIG. 19, a UE sends a first part of a report to a gNB at block 1906. At block 1908, the gNB receives the first part of the report and sends an acknowledgement to the UE at block 1910. In one example, the acknowledgement includes resource allocation information e.g., UL grant for second part/resource. In one example, the acknowledgement is for pre-configured resources. At block 1912, the UE receives the acknowledgement, and sends a second part of the report to the gNB at block 1914. At block 1916 the gNB receives the second part of the report.

although FIG. 19 illustrates an example 1900 of a UE sending a first stage/part and a second stage/part of a report to a network, various changes may be made to FIG. 19. For example, while shown as a series of steps, various steps in FIG. 19 could overlap, occur in parallel, occur in a different order, or occur any number of times.

In one embodiment, after sending the first stage or the first part of report, if the UE doesn't receive an acknowledgement, the UE can re-transmit the first stage or the first part of report or a new first stage or first part of report.

In one embodiment, after sending the first stage or the first part of report, the UE expects an acknowledgment at time T, or after a time T (for example, first symbol or slot or sub-frame or frame boundary at or after a time T) from the first stage or the first part of report. In one example, T is from the start of the signal/channel of the first stage or the first part of report. In one example T, is from the end of the signal/channel of the first stage or the first part of report. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the first stage or the first part of report and/or signal/channel with acknowledgement to the UE and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment at time T, as aforementioned, the UE can retransmit the first stage or the first part of report or transmit a new first stage or first part of report. In one example, if the UE receives an acknowledgment at time T, as aforementioned, the UE can transmit a second stage or a second part of report.

In one embodiment, after sending the first stage or the first part of report, the UE expects an acknowledgment before time T (or before or at time T) from the first stage or the first part of report. In one example, T is from the start of the signal/channel of the first stage or the first part of report. In one example, T is from the end of the signal/channel of the first stage or the first part of report. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the first stage or the first part of report and/or signal/channel with acknowledgement to the UE and/or channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment before time T (or before or at time T), as aforementioned, the UE can retransmit the first stage or the first part of report or transmit a new first stage or first part of report. In one example, if the UE receives an acknowledgment before time T (or before or at time T), as aforementioned, the UE transmits a second stage or a second part of report.

In one embodiment, after sending the first stage or the first part of report, the UE expects an acknowledgment at time t, or after a time t (for example, first symbol or slot or sub-frame or frame boundary at or after a time t) from the first stage or the first part of report, such that one of (1) T1<t<T2, or (2) T1≤t≤T2 or (3) T1<t≤T2 or (4) T1≤t<T2. In one example, T1 and/or T2 is from the start of the signal/channel of the first stage or the first part of report. In one example, T1 and/or T2 is from the end of the signal/channel of the first stage or the first part of report. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot containing the signal/channel with acknowledgment to the UE. In one example T1 and/or T2 is to the end of the slot containing the signal/channel with acknowledgement to the UE. In one example, T1 and/or T2 is specified by system specifications and/or configured or updated by RRC signaling and/or MAC CE signaling and/or L1 control (e.g., DCI) signaling. In one example, T1 and/or T2 depends on the sub-carrier spacing of the signal/channel of the first stage or the first part of report and/or signal/channel with acknowledgement to the UE and/or channel of a second stage or a second part of report. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, if the UE doesn't receive an acknowledgment at time t, the UE can retransmit the first stage or the first part of report or a new first stage or first part of report, such that one of (1) T1<t<T2, or (2) T1≤t≤T2 or (3) T1<t≤T2 or (4) T1≤t<T2. In one example, if the UE receives an acknowledgment at time t, as aforementioned, the UE can transmit a report a second stage or a second part of report.

In one embodiment, after sending a first stage or a first part of report, and after receiving an acknowledgement, the UE can transmit a second stage or a second part of report.

In one embodiment, after sending a first stage or a first part of report, and after receiving an acknowledgement, the UE transmits a second stage or a second part of report at time t, or after a time t (for example, first symbol or slot or sub-frame or frame boundary at or after a time t). In one example, time t is a duration T from the start of the signal/channel of the first stage or the first part of report. In one example, time t is a duration T from the end of the signal/channel of the first stage or the first part of report. In one example, time t is a duration T from the start of the signal/channel with the acknowledgment to the UE. In one example, time t is a duration T from the end of the signal/channel with the acknowledgment to the UE. In one example, T is specified by system specifications and/or configured or updated by RRC signaling and/or MAC CE signaling and/or L1 control (e.g., DCI) signaling. In one example, T depends on the sub-carrier spacing of the signal/channel of the first stage or the first part of report and/or signal/channel with acknowledgement to the UE and/or channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, after sending a first stage or a first part of report, and after receiving an acknowledgement, the UE transmits a second stage or a second part of report at time t, or after a time t (for example, first symbol or slot or sub-frame or frame boundary at or after a time t). In one example, time t is between a duration T1 (inclusive or exclusive) and a duration T2 (inclusive or exclusive) from the start of the signal/channel of the first stage or the first part of report. In one example, time t is between a duration T1 (inclusive or exclusive) and a duration T2 (inclusive or exclusive) from the end of the signal/channel of the first stage or the first part of report. In one example, time t is between a duration T1 (inclusive or exclusive) and a duration T2 (inclusive or exclusive) from the start of the signal/channel with the acknowledgment to the UE. In one example, time t is between a duration T1 (inclusive or exclusive) and a duration T2 (inclusive or exclusive) from the end of the signal/channel with the acknowledgment to the UE. In one example, T1 and/or T2 is specified by system specifications and/or configured or updated by RRC signaling and/or MAC CE signaling and/or L1 control (e.g., DCI) signaling. In one example, T1 and/or T2 depends on the sub-carrier spacing of the signal/channel of the first stage or the first part of report and/or signal/channel with acknowledgement to the UE and/or signal/channel of the second stage or the second part of report. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, T1 can be zero. In one example, T2 can be infinity.

In one embodiment, after sending a first first-stage or a first first-part of report if the UE doesn't receive the acknowledgment, the UE can transmit a second first-stage or a second first-part of report after time T (or at or after time T, or at time T). In one example, T is from the start of the first first-stage or a first first-part of report. In one example, T is from the end of the first first-stage or the first first-part of report. In one example T, is from the start of the signal/channel with acknowledgment to the UE of the first first-stage or a first first-part of report (e.g., this can be based on the latest expected acknowledgement to the first first-stage or the first first-part of report). In one example T, is from the end of the signal/channel with acknowledgment to the UE of the first first-stage or the first first-part of report channel/signal (e.g., this can be based on the latest expected acknowledgement to the first first-stage or the first first-part of report). In one example, T is specified by system specifications and/or configured or updated by RRC signaling and/or MAC CE signaling and/or L1 control (e.g., DCI) signaling. In one example, T depends on the sub-carrier spacing of the signal/channel of the scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, the acknowledgement to the first stage or the first part of report can be a DCI Format acknowledging the reception of the first stage or the first part of report.

In one embodiment, the acknowledgement to the first stage or the first part of report can be a channel/signal allocating/scheduling UL resources for the second stage or the second part of report from UE. For example, this can be a DCI Format in PDCCH transmission that includes UL grant. For example, this can be DCI Format 0_0 or DCI Format 0_1 or DCI Format 0_2.

In one embodiment, the first stage/part of report from the UE is semi-persistent, wherein the UE sends the first stage/part of report with a periodicity P and until a time T expires and/or for N instances. The gNB/TRP/network can acknowledge the first stage/part UE report. In one example, T and/or P and/or N can be specified by system specifications and/or configured or updated by RRC signaling and/or MAC CE signaling and/or L1 control (e.g., DCI) signaling.

In one embodiment, the first stage/part of report from the UE is semi-persistent, wherein the UE sends the first stage/part of report with a periodicity P and until one of the following events occurs: (1) a time T expires and/or for N instances (2) the UE receives an acknowledgement from the gNB/TRP/network. In one example, T and/or P and/or N can be specified by system specifications and/or configured or updated by RRC signaling and/or MAC CE signaling and/or L1 control (e.g., DCI) signaling.

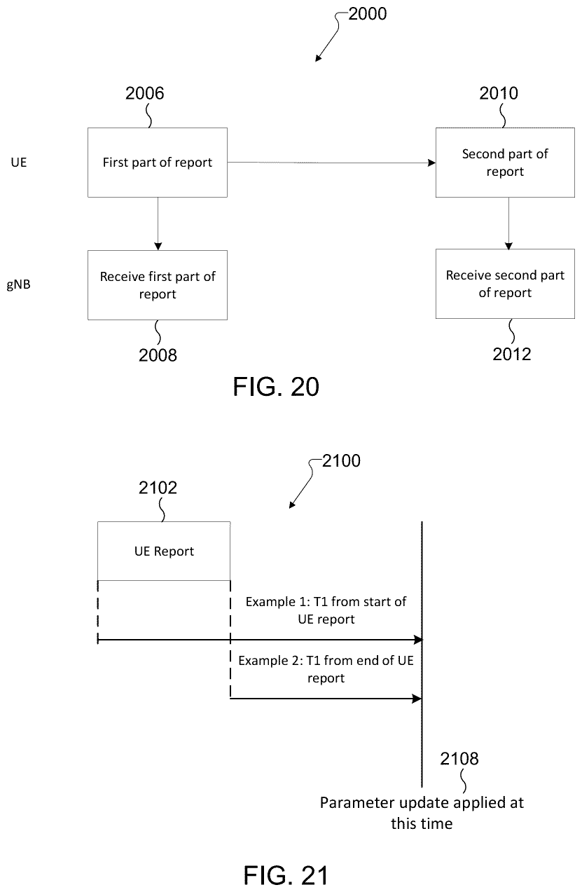

In one embodiment, the UE can send a signal to the gNB/TRP/network, wherein the signal can be a first stage or a first part report from the UE. There is no acknowledgment for the first stage or the first part report from the UE. The UE sends a second stage or a second part report after sending the first stage or the first part of report. This is illustrated in FIG. 20.

FIG. 20 illustrates an example 2000 of a UE sending a first stage/part and a second stage/part of a report to a network without receiving an acknowledgment according to embodiments of the present disclosure. The embodiment of a UE sending a first stage/part and a second stage/part of a report to a network without receiving an acknowledgment of FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a UE sending a first stage/part and a second stage/part of a report to a network without receiving an acknowledgment could be used without departing from the scope of this disclosure. In one example, the first stage/part and the second stage/part are transmitted in a same UL channel. In one example, the first stage/part and the second stage/part are transmitted in a same slot. In one example, the first stage/part and the second stage/part are transmitted in a first UL channel and a second UL channel respectively. In one example, the first stage/part and the second stage/part are transmitted in a first slot and a second slot respectively.

In the example of FIG. 20, a UE sends a first part of a report to a gNB at block 2006. At block 2008, the gNB receives the first part of the report. At block 2010, the UE sends a second part of the report to the gNB. At block 2012 the gNB receives the second part of the report.

Although FIG. 20 illustrates an example an example 2000 of a UE sending a first stage/part and a second stage/part of a report to a network without receiving an acknowledgment, various changes may be made to FIG. 20. For example, while shown as a series of steps, various steps in FIG. 20 could overlap, occur in parallel, occur in a different order, or occur any number of times.

In one embodiment, after sending the first stage or the first part of report, the UE transmits a second stage or a second part of report at time t, or after a time t (for example, first symbol or slot or sub-frame or frame boundary at or after a time t). In one example, time t is a duration T from the start of the signal/channel of the first stage or the first part of report. In one example, time t is a duration T from the end of the signal/channel of the first stage or the first part of report. In one example, T is specified by system specifications and/or configured or updated by RRC signaling and/or MAC CE signaling and/or L1 control (e.g., DCI) signaling. In one example, T depends on the sub-carrier spacing of the signal/channel of the first stage or the first part of report and/or signal/channel of the second stage or the second part of report. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, after sending the first stage or the first part of report, the UE transmits a second stage or a second part of report at time t, or after a time t (for example, first symbol or slot or sub-frame or frame boundary at or after a time t). In one example, time t is between a duration T1 (inclusive or exclusive) and a duration T2 (inclusive or exclusive) from the start of the signal/channel of the first stage or the first part of report. In one example, time t is between a duration T1 (inclusive or exclusive) and a duration T2 (inclusive or exclusive) from the end of the signal/channel of the first stage or the first part of report. In one example, T1 and/or T2 is specified by system specifications and/or configured or updated by RRC signaling and/or MAC CE signaling and/or L1 control (e.g., DCI) signaling. In one example T1 and/or T2, depends on the sub-carrier spacing of the signal/channel of the first stage or the first part of report and/or signal/channel of the second stage or the second part of report. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, T1 can be zero. In one example, T2 can be infinity.

In one embodiment, the UE can send a second stage or a second part of report in UL resources to the gNB/TRP/Network. If the gNB/TRP/Network receives the second stage or the second part of report, the gNB/TRP/Network can acknowledge the second stage or the second part of report.

In one embodiment, after sending the second stage or the second part of report, if the UE doesn't receive an acknowledgement, the UE can re-transmit the second stage or the second part of report or transmit a new second stage or second part of report.

In one embodiment, after sending the second stage or the second part of report, the UE expects an acknowledgment at time T, or after a time T (for example, first symbol or slot or sub-frame or frame boundary at or after a time T) from the second stage or the second part of report. In one example, T is from the start of the signal/channel that includes the second stage or the second part of report. In one example T, is from the end of the signal/channel that includes the second stage or the second part of report. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel that includes the second stage or the second part of report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment at time T, as aforementioned, the UE can retransmit the second stage or the second part of report or a new second stage or second part of report. In one example, if the UE receives an acknowledgment at time T, as aforementioned, the UE can update a parameter based on the report as described later in this disclosure.

In one embodiment, after sending the second stage or the second part of report, the UE expects an acknowledgment before time T (or before or at time T) from the second stage or the second part of report. In one example, T is from the start of the signal/channel that includes the second stage or the second part of report. In one example, T is from the end of the signal/channel that includes the second stage or the second part of report. In one example, T is to the start of the signal/channel with acknowledgment to the UE. In one example, T is to the end of the signal/channel with acknowledgment to the UE. In one example, T is to the start of the slot containing the signal/channel with acknowledgment to the UE. In one example, T is to the end of the slot containing the signal/channel with acknowledgement to the UE. In one example, T is specified by system specifications and/or configured or updated by RRC signaling and/or MAC CE signaling and/or L1 control (e.g., DCI) signaling. In one example, T depends on the sub-carrier spacing of the signal/channel that includes the second stage or the second part of report and/or signal/channel with acknowledgement to the UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.). In one example, if the UE doesn't receive an acknowledgment before time T (or before or at time T), as aforementioned, the UE can retransmit the second stage or the second part of report or a new second stage or second part of report. In one example, if the UE receives an acknowledgment before time T (or before or at time T), as aforementioned, the UE can update a parameter based on the report as described later in this disclosure.

In one embodiment after sending the second stage or the second part of report, the UE expects an acknowledgment at time t, or after a time t (for example, first symbol or slot or sub-frame or frame boundary at or after a time t) from the second stage or the second part of report, such that one of (1) T1<t<T2, or (2) T1≤t≤T2 or (3) T1<t≤T2 or (4) T1≤t<T2. In one example, T1 and/or T2 is from the start of the signal/channel that includes the second stage or the second part of report. In one example, T1 and/or T2 is from the end of the signal/channel that includes the second stage or the second part of report. In one example, T1 and/or T2 is to the start of the signal/channel with acknowledgment to the UE. In one example, T1 and/or T2 is to the end of the signal/channel with acknowledgment to the UE. In one example, T1 and/or T2 is to the start of the slot containing the signal/channel with acknowledgment to the UE. In one example T1 and/or T2 is to the end of the slot containing the signal/channel with acknowledgement to the UE. In one example, T1 and/or T2 is specified by system specifications and/or configured or updated by RRC signaling and/or MAC CE signaling and/or L1 control (e.g., DCI) signaling. In one example, T1 and/or T2 depends on the sub-carrier spacing of the signal/channel that includes the second stage or the second part of report and/or signal/channel with acknowledgement to the UE. In one example, T1 and/or T2 depends on a UE capability. In one example, T1 and/or T2 can be in units of symbols. In one example, T1 and/or T2 can be in units of slots. In one example, T1 and/or T2 can be in units of sub-frames. In one example, T1 and/or T2 can be in units of frames. In one example, T1 and/or T2 can be in units of time (e.g., millisecond, seconds, etc.). In one example, if the UE doesn't receive an acknowledgment at time t, the UE can retransmit the second stage or the second part of report or a new second stage or second part of report, such that one of (1) T1<t<T2, or (2) T1≤t≤T2 or (3) T1<t≤T2 or (4) T1≤t<T2. If the UE receives an acknowledgment at time t, as aforementioned, the UE can update a parameter based on the report as described later in this disclosure.

In one embodiment, after sending a first second-stage or the first second-part of report if the UE doesn't receive the acknowledgement, the UE can transmit a second second-stage or a second second-part of report after time T (or at or after time T, or at time T), e.g., the second second-stage or the second second-part of report can be a re-transmission of the first second-stage or the first second-part of report or a new second-stage or second-part of report. In one example, T is from the start of the signal/channel that includes the first second-stage or the first second-part of report. In one example, T is from the end of the signal/channel that includes the first second-stage or the first second-part of report. In one example T, is from the start of the signal/channel with acknowledgment to the UE of the first second-stage or the first second-part of report (e.g., this can be based on the latest expected acknowledgement to the first report). In one example T, is from the end of the signal/channel with acknowledgment to the UE of the first second-stage or the first second-part of report (e.g., this can be based on the latest expected acknowledgement to the first report).

In one embodiment, after sending a first second-stage/part of report (for example this can be associated with a first first-stage/part of report that is not acknowledged) if the UE doesn't receive the acknowledgement for the first second-stage/part of report, the UE can transmit a second first-stage/part of UE report followed by a second of second-stage/part of UE report after time T (or at or after time T, or at time T), e.g., the second first-stage part of report and/or the second second-stage part of report can be a re-transmission of the first first-stage/part of report or the first second-stage/part of report respectively, or a new first-stage/part of report and/or second-stage part of report. In one example, T is from the start of the signal/channel that includes the first second-stage/part of report. In one example, T is from the end of the signal/channel that includes the first second-stage/part of report. In one example T, is from the start of the signal/channel with acknowledgment to the UE of the first second-stage/part of report (e.g., this can be based on the latest expected acknowledgement to the first report). In one example T, is from the end of the signal/channel with acknowledgment to the UE of the first second-stage/part of report (e.g., this can be based on the latest expected acknowledgement to the first report). In one example, T is specified by system specifications and/or configured or updated by RRC signaling and/or MAC CE signaling and/or L1 control (e.g., DCI) signaling. In one example, T depends on the sub-carrier spacing of the signal/channel of the scheduling request and/or signal/channel with acknowledgement to the UE and/or channel of report from UE. In one example, T depends on a UE capability. In one example, T can be in units of symbols. In one example, T can be in units of slots. In one example, T can be in units of sub-frames. In one example, T can be in units of frames. In one example, T can be in units of time (e.g., millisecond, seconds, etc.).

In one embodiment, the acknowledgement to the second stage or the second part of report from the UE can be a DCI Format acknowledging the reception of the second stage or the second part of report from the UE.

In one embodiment, there is no acknowledgement to the second stage or the second part of report from the UE.

In one embodiment, the second stage/part of report from the UE is semi-persistent, wherein the UE sends the second stage/part of report with a periodicity P and until a time T expires and/or for N instances. The gNB/TRP/network can acknowledge the second stage/part UE report. In one example, T and/or P and/or N can be specified by system specifications and/or configured or updated by RRC signaling and/or MAC CE signaling and/or L1 control (e.g., DCI) signaling.

In one embodiment, the second stage/part of report from the UE is semi-persistent, wherein the UE sends the second stage/part of report with a periodicity P and until one of the following events occurs: (1) a time T expires and/or for N instances (2) the UE receives an acknowledgement from the gNB/TRP/network. In one example, T and/or P and/or N can be specified by system specifications and/or configured or updated by RRC signaling and/or MAC CE signaling and/or L1 control (e.g., DCI) signaling.

In one embodiment, the UE can send a signal to the gNB/TRP/network, wherein the signal can be a first stage/part of report from the UE. There is no acknowledgment for the first stage/part of report from the UE. The UE sends a second stage/part pf report from UE after sending the first stage/part of report from UE. In one example, the first stage/part and the second stage/part are transmitted in a same UL channel. In one example, the first stage/part and the second stage/part are transmitted in a same slot. In one example, the first stage/part and the second stage/part are transmitted in a first UL channel and a second UL channel respectively. In one example, the first stage/part and the second stage/part are transmitted in a first slot and a second slot respectively. This is illustrated in FIG. 20. There can be one acknowledgment sent after the second stage/part of report from UE. This acknowledgement can be associated with the first stage/part of report from UE and the second stage/part of report from UE.
In one embodiment, if first stage/part of report from UE is not received (e.g., not successfully decoded or detected) by the gNB/TRP/Network, there is no acknowledgement sent from the gNB/TRP/Network to the UE.
In one embodiment, if first stage/part of report from UE is received (e.g., successfully decoded or detected) by the gNB/TRP/Network, but second stage/part of report from UE is not received (e.g., not successfully decoded or detected) by the gNB/TRP/Network, there is an acknowledgement indicating that the first stage/part of report from UE has been received, but the second stage/part of report from UE has not been received. For example, this can be a negative acknowledgement (e.g., NACK).
In one embodiment, if first stage/part of report from UE is received (e.g., successfully decoded or detected) by the gNB/TRP/Network, and second stage/part of report from UE is received (e.g., successfully decoded or detected) by the gNB/TRP/Network, there is an acknowledgement indicating that the first and second stage/part of report from UE has been received. For example, this can be a positive acknowledgement (e.g., ACK).

The timing of the acknowledgement and re-transmissions, if any, or new transmissions, if any, that is associated with the first and second stage/part of report from UE can follow the timing of the acknowledgement or re-transmissions or new transmissions associated with the second stage/part of report from UE as aforementioned.

In one embodiment, the first and second stage/part of report from the UE is semi-persistent, wherein the UE sends the first and second stage/part of report with a periodicity P and until a time T expires and/or for N instances. The gNB/TRP/network can acknowledge the first and second stage/part UE report. In one example, T and/or P and/or N can be specified by system specifications and/or configured or updated by RRC signaling and/or MAC CE signaling and/or L1 control (e.g., DCI) signaling.

In one embodiment, the first and second stage/part of report from the UE is semi-persistent, wherein the UE sends the first and second stage/part of report with a periodicity P and until one of the following events occurs: (1) a time T expires and/or for N instances (2) the UE receives an acknowledgement from the gNB/TRP/network. In one example, T and/or P and/or N can be specified by system specifications and/or configured or updated by RRC signaling and/or MAC CE signaling and/or L1 control (e.g., DCI) signaling.

After a report or message from the UE has been sent to the network, one or more parameters can be updated based on that report.

In one embodiment, the TCI state or states used for DL channels or DL signals or the TCI state or states used for UL channels or UL signals can be updated based on the report or message from the UE.

In one embodiment, handover or mobility can be triggered based on the report or message from the UE.

In one embodiment, UL timing (e.g., TA value) can be updated based on the report or message from the UE.

In one embodiment, the parameter(s) for a CSI report can be selected/updated/configured.
For example, the codebook type can be updated from Type I to Type II or vice versa.
For example, the rank (RI) value(s) for the report can be selected/updated.

In one embodiment, the parameter(s) for the DL transmission (e.g., PDSCH) can be selected/updated/configured.
For example, MCS, DMRS precoding, number of layers etc. can be selected.

In one embodiment, the parameter(s) for the UL transmission (e.g., PUSCH) can be selected/updated/configured.
For example, MCS, DMRS precoding, number of layers etc. can be selected.

In one embodiment, the parameter(s) for the DL RS (e.g., CSI-RS, DMRS) can be selected/updated/configured.

In one embodiment, the parameter(s) for the UL RS (e.g., SRS, DMRS) can be selected/updated/configured.

In some embodiments when parameters are updated in the UE and the gNB/TRP/Network, the timing of the update is synchronized.

In one embodiment, a UE report can comprise one part or one stage. A parameter is updated based on the UE report. The parameter is updated at a time T1, or after a time T1 (for example, first symbol or slot or sub-frame or frame boundary at or after a time T1) from the UE report. In one example, the UE report has an acknowledgement, but the parameter update takes effect regardless of the acknowledgement. In one example, the UE report has no acknowledgement.

FIG. 21 illustrates an example 2100 of applying a parameter update at a particular time according to embodiments of the present disclosure. The embodiment of applying a parameter update at a particular time of FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments of applying a parameter update at a particular time could be used without departing from the scope of this disclosure.

In the example of FIG. 21, a UE sends a UE report 2102. At 2108, a parameter update is applied at a time T1.

In one embodiment, the update of the parameter is at time T1 from the start of the one part or one stage UE report 2102. This is illustrated in FIG. 21 Example 1.

In one embodiment, the update of the parameter is at time T1 from the end of the one part or one stage UE report 2102. This is illustrated in FIG. 21 Example 2.

Although FIG. 21 illustrates an example an example 2100 of applying a parameter update at a particular time, various changes may be made to FIG. 21. For example, while shown as a series of steps, various steps in FIG. 21 could overlap, occur in parallel, occur in a different order, or occur any number of times.

In one embodiment, the update of the parameter is at the first symbol boundary at or after time T1 from the start of the UE report.

In one embodiment, the update of the parameter is at the first symbol boundary at or after time T1 from the end of the UE report.

In one embodiment, the update of the parameter is at the first slot boundary at or after time T1 from the start of the UE report.

In one embodiment, the update of the parameter is at the first slot boundary at or after time T1 from the end of the UE report.

In one embodiment, the update of the parameter is at the first sub-frame boundary at or after time T1 from the start of the UE report.

In one embodiment, the update of the parameter is at the first sub-frame boundary at or after time T1 from the end of the UE report.

In one embodiment, the update of the parameter is at the first frame boundary at or after time T1 from the start of the UE report.

In one embodiment, the update of the parameter is at the first frame boundary at or after time T1 from the end of the UE report.

In one embodiment, the update of the parameter is at the first SFN roll-over boundary (SFN=0) at or after time T1 from the start of the UE report.

In one embodiment, the update of the parameter is at the first SFN roll-over boundary (SFN=0) at or after time T1 from the end of the UE report.

In one embodiment, T1 is specified by system specifications and/or configured or updated by RRC signaling and/or MAC CE signaling and/or L1 control (e.g., DCI) signaling.

In one embodiment, T1 can depend on the sub-carrier spacing of the signal/channel that includes the report and/or acknowledgement (when applicable) and/or BWP or carrier to which the parameter update is associated.

In one embodiment, T1 can depend on a UE capability.

In one embodiment, T1 can be in units of symbols.

In one embodiment, T1 can be in units of slots.

In one embodiment, T1 can be in units of sub-frames.

In one embodiment, T1 can be in units of frames.

In one embodiment, T1 can be in units of time (e.g., millisecond, seconds, etc.).

In one embodiment, a UE report can comprise one part or one stage. A parameter is updated based on the UE report. The parameter is updated after a time T1 from the UE report and after acknowledgement of the UE report.

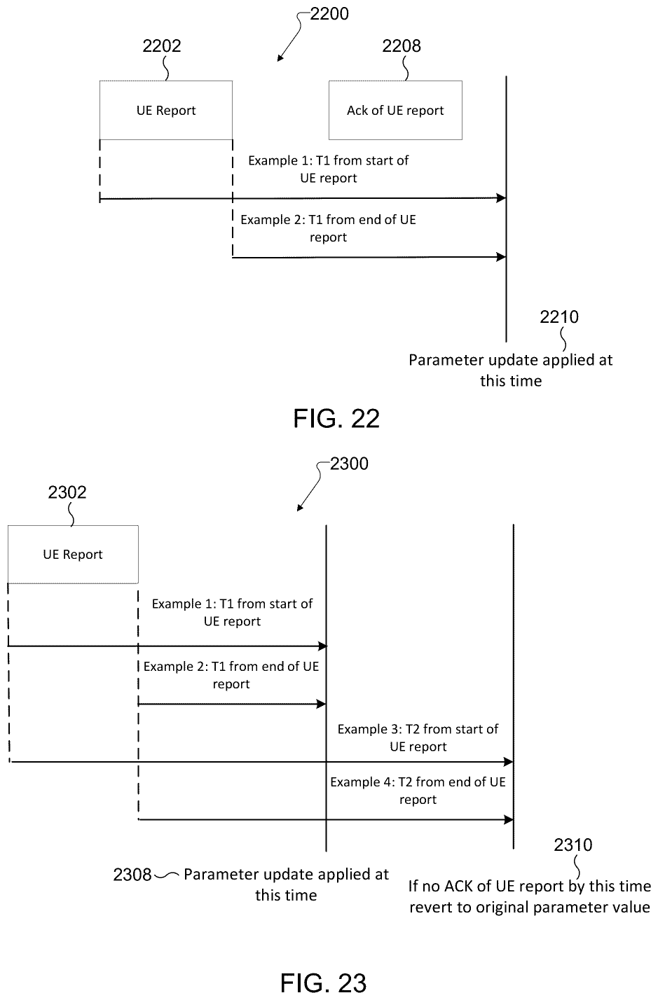

FIG. 22 illustrates an example 2200 of applying a parameter update at a particular time and after acknowledgment of a UE report according to embodiments of the present disclosure. The embodiment of applying a parameter update at a particular time and after acknowledgment of a UE report of FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of applying a parameter update at a particular time and after acknowledgment of a UE report could be used without departing from the scope of this disclosure.

In the example of FIG. 22, a UE sends a UE report 2202, and receives an acknowledgment 2208 of the UE report. At 2210, after the receipt of acknowledgement 2208, a parameter update is applied at a time T1, or after a time T1 (for example, first symbol or slot or sub-frame or frame boundary at or after a time T1).

In one embodiment, the update of the parameter is at time T1 from the start of the one part or one stage UE report 2202 as long as acknowledgement 2208 for the UE report is transmitted by the gNB/TRP/network or acknowledgement 2208 for the UE report is received by the UE. This is illustrated in FIG. 22 Example 1.

In one embodiment, the update of the parameter is at time T1 from the end of the one part or one stage UE report 2208 as long as acknowledgement 2208 for the UE report is transmitted by the gNB/TRP/network or acknowledgement 2208 for the UE report is received by the UE. This is illustrated in FIG. 22 Example 2.

Although FIG. 22 illustrates an example an example 2200 of applying a parameter update at a particular time and after acknowledgment of a UE report, various changes may be made to FIG. 22. For example, while shown as a series of steps, various steps in FIG. 22 could overlap, occur in parallel, occur in a different order, or occur any number of times.

In one embodiment, the update of the parameter is at the first symbol boundary at or after time T1 from the start of the UE report, and as long as an acknowledgement for the UE report is transmitted by the gNB/TRP/network or an acknowledgement for the UE report is received by the UE.

In one embodiment, the update of the parameter is at the first symbol boundary at or after time T1 from the end of the UE report, and as long as an acknowledgement for the UE report is transmitted by the gNB/TRP/network or an acknowledgement for the UE report is received by the UE.

In one embodiment, the update of the parameter is at the first slot boundary at or after time T1 from the start of the UE report, and as long as an acknowledgement for the UE report is transmitted by the gNB/TRP/network or an acknowledgement for the UE report is received by the UE.

In one embodiment, the update of the parameter is at the first slot boundary at or after time T1 from the end of the UE report, and as long as an acknowledgement for the UE report is transmitted by the gNB/TRP/network or an acknowledgement for the UE report is received by the UE.

In one embodiment, the update of the parameter is at the first sub-frame boundary at or after time T1 from the start of the UE report, and as long as an acknowledgement for the UE report is transmitted by the gNB/TRP/network or an acknowledgement for the UE report is received by the UE.

In one embodiment, the update of the parameter is at the first sub-frame boundary at or after time T1 from the end of the UE report, and as long as an acknowledgement for the UE report is transmitted by the gNB/TRP/network or an acknowledgement for the UE report is received by the UE.

In one embodiment, the update of the parameter is at the first frame boundary at or after time T1 from the start of the UE report, and as long as an acknowledgement for the UE report is transmitted by the gNB/TRP/network or an acknowledgement for the UE report is received by the UE.

In one embodiment, the update of the parameter is at the first frame boundary at or after time T1 from the end of the UE report, and as long as an acknowledgement for the UE report is transmitted by the gNB/TRP/network or an acknowledgement for the UE report is received by the UE.

In one embodiment, the update of the parameter is at the first SFN roll-over boundary (SFN=0) at or after time T1 from the start of the UE report, and as long as an acknowledgement for the UE report is transmitted by the gNB/TRP/network or an acknowledgement for the UE report is received by the UE.

In one embodiment, the update of the parameter is at the first SFN roll-over boundary (SFN=0) at or after time T1 from the end of the UE report, and as long as an acknowledgement for the UE report is transmitted by the gNB/TRP/network or an acknowledgement for the UE report is received by the UE.

In one embodiment, T1 is specified by system specifications and/or configured or updated by RRC signaling and/or MAC CE signaling and/or L1 control (e.g., DCI) signaling.

In one embodiment, T1 can depend on the sub-carrier spacing of the signal/channel that includes the report and/or acknowledgement and/or BWP or carrier to which the parameter update is associated.

In one embodiment, T1 can depend on a UE capability.

In one embodiment, T1 can be in units of symbols.

In one embodiment, T1 can be in units of slots.

In one embodiment, T1 can be in units of sub-frames.

In one embodiment, T1 can be in units of frames.

In one embodiment, T1 can be in units of time (e.g., millisecond, seconds, etc.).

In one embodiment, a UE report can comprise one part or one stage. A parameter is updated based on the UE report. The parameter is updated at a time T1, or after a time T1 (for example, first symbol or slot or sub-frame or frame boundary at or after a time T1) from the UE report. If no acknowledgement is received by time T2, or after a time T2 (for example, first symbol or slot or sub-frame or frame boundary at or after a time T2) for the UE report, or if the UE doesn't perceive that the parameter has changed at the gNB by time T2, the UE reverts back to the original parameter setting.

FIG. 23 illustrates an example 2300 of reverting to an original parameter value after failing to receive an acknowledgment of a UE report according to embodiments of the present disclosure. The embodiment of reverting to an original parameter value after failing to receive an acknowledgment of a UE report of FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of reverting to an original parameter value after failing to receive an acknowledgment of a UE report could be used without departing from the scope of this disclosure.

In the example of FIG. 23, a UE sends a UE report 2302. At 2308, a parameter update is applied at a time T1. At 2310, if no acknowledgement of the UE report has been received by time T2, the original parameter value is reverted to.

In one embodiment, the update of the parameter is at time T1 from the start of the one part or one stage UE report 2302. This is illustrated in FIG. 23 Example 1.

In one embodiment, the update of the parameter is at time T1 from the end of the one part or one stage UE report 2302. This is illustrated in FIG. 23 Example 2.

In one embodiment, the parameter reverts back to the original value (original parameter setting) at (or at or after) time T2 from the start of the one part or one stage UE report 2302, if no acknowledgement is received for the UE report 2302, or if the UE doesn't perceive that the parameter has changed at the gNB. This is illustrated in FIG. 23 Example 3.

In one embodiment, the parameter reverts back to the original value (original parameter setting) at (or at or after) time T2 from the end of the one part or one stage UE report 2302, if no acknowledgement is received for the UE report 2302, or if the UE doesn't perceive that the parameter has changed at the gNB. This is illustrated in FIG. 23 Example 4.

Although FIG. 23 illustrates an example an example 2300 of reverting to an original parameter value after failing to receive an acknowledgment of a UE report, various changes may be made to FIG. 23. For example, while shown as a series of steps, various steps in FIG. 23 could overlap, occur in parallel, occur in a different order, or occur any number of times.

In one embodiment, the update of the parameter is at the first symbol boundary at or after time T1 from the start of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first symbol boundary at or after time T1 from the end of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first slot boundary at or after time T1 from the start of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first slot boundary at or after time T1 from the end of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first sub-frame boundary at or after time T1 from the start of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first sub-frame boundary at or after time T1 from the end of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first frame boundary at or after time T1 from the start of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first frame boundary at or after time T1 from the end of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first SFN roll-over boundary (SFN=0) at or after time T1 from the start of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first SFN roll-over boundary (SFN=0) at or after time T1 from the end of the UE report. If no acknowledgement is received by time T2 for the UE report, or if the UE doesn't perceive that the parameter has changed at the gNB by time T2, the UE reverts back to the original parameter setting.

In one embodiment, T1 and/or T2 is/are specified by system specifications and/or configured or updated by RRC signaling and/or MAC CE signaling and/or L1 control (e.g., DCI) signaling.

In one embodiment, T1 and/or T2 can depend on the sub-carrier spacing of the signal/channel that includes the report and/or acknowledgement and/or BWP or carrier to which the parameter update is associated.

In one embodiment, T1 and/or T2 can depend on a UE capability.

In one embodiment, T1 and/or T2 can be in units of symbols.

In one embodiment, T1 and/or T2 can be in units of slots.

In one embodiment, T1 and/or T2 can be in units of sub-frames.

In one embodiment, T1 and/or T2 can be in units of frames.

In one embodiment, T1 and/or T2 can be in units of time (e.g., millisecond, seconds, etc.).

In one embodiment, a UE report can comprise one part or one stage. A parameter is updated based on the UE report. The parameter is updated after a time T1 from the acknowledgment of the UE report.

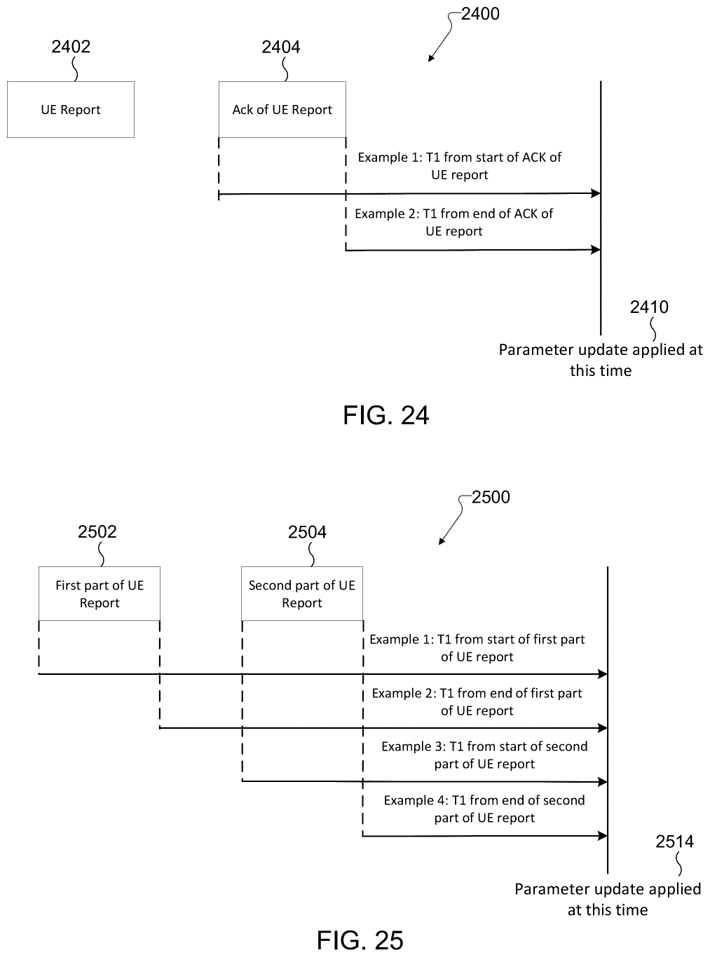

FIG. 24 illustrates an example 2400 of applying a parameter update at a particular time after acknowledgment of a UE report according to embodiments of the present disclosure. The embodiment of applying a parameter update at a particular time after acknowledgment of a UE report of FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of applying a parameter update at a particular time after acknowledgment of a UE report could be used without departing from the scope of this disclosure.

In the example of FIG. 24, a UE sends a UE report 2402, and receives an acknowledgment 2404 of the UE report. At 2410, a parameter update is applied at a time T1, or after a time T1 (for example, first symbol or slot or sub-frame or frame boundary at or after a time T1) after the receipt of acknowledgement 2404.

In one embodiment, the update of the parameter is at time T1 from the start of the acknowledgement of the UE report. This is illustrated in FIG. 24 Example 1.

In one embodiment, the update of the parameter is at time T1 from the end of the acknowledgement of the UE report. This is illustrated in FIG. 24 Example 2.

Although FIG. 24 illustrates an example an example 2400 of applying a parameter update at a particular time after acknowledgment of a UE report, various changes may be made to FIG. 24. For example, while shown as a series of steps, various steps in FIG. 24 could overlap, occur in parallel, occur in a different order, or occur any number of times.

In one embodiment, the update of the parameter is at the first symbol boundary at or after time T1 from the start of the acknowledgement of the UE report.

In one embodiment, the update of the parameter is at the first symbol boundary at or after time T1 from the end of the acknowledgement of the UE report.

In one embodiment, the update of the parameter is at the first slot boundary at or after time T1 from the start of the acknowledgement of the UE report.

In one embodiment, the update of the parameter is at the first slot boundary at or after time T1 from the end of the acknowledgement of the UE report.

In one embodiment, the update of the parameter is at the first sub-frame boundary at or after time T1 from the start of the acknowledgement of the UE report.

In one embodiment, the update of the parameter is at the first sub-frame boundary at or after time T1 from the end of the acknowledgement of the UE report.

In one embodiment, the update of the parameter is at the first frame boundary at or after time T1 from the start of the acknowledgement of the UE report.

In one embodiment, the update of the parameter is at the first frame boundary at or after time T1 from the end of the acknowledgement of the UE report.

In one embodiment, the update of the parameter is at the first SFN roll-over boundary (SFN=0) at or after time T1 from the start of the acknowledgement of the UE report.

In one embodiment, the update of the parameter is at the first SFN roll-over boundary (SFN=0) at or after time T1 from the end of the acknowledgement of the UE report.

In one embodiment, T1 is specified by system specifications and/or configured or updated by RRC signaling and/or MAC CE signaling and/or L1 control (e.g., DCI) signaling.

In one embodiment, T can depend on the sub-carrier spacing of the signal/channel that includes the report and/or acknowledgement and/or BWP or carrier to which the parameter update is associated.

In one embodiment, T1 can depend on a UE capability.

In one embodiment, T1 can be in units of symbols.

In one embodiment, T1 can be in units of slots.

In one embodiment, T1 can be in units of sub-frames.

In one embodiment, T1 can be in units of frames.

In one embodiment, T1 can be in units of time (e.g., millisecond, seconds, etc.).

In one embodiment, a UE report can comprise two parts or two stages. A parameter is updated based on the UE report. The parameter is updated at a time T1, or after a time T1 (for example, first symbol or slot or sub-frame or frame boundary at or after a time T1) from the UE report. In one example, the UE report has an acknowledgement, but the parameter update takes effect regardless of the acknowledgement. In one example, the UE report has no acknowledgement. In one example, the acknowledgement can be for the first part/stage only. In one example, the acknowledgment can be for the second part/stage only. In one example, there is an acknowledgment for the first part/stage and an acknowledgement for the second part/stage.

FIG. 25 illustrates an example 2500 of applying a parameter update at a particular time after receiving a first or second part of a UE report according to embodiments of the present disclosure. The embodiment of applying a parameter update at a particular time after receiving a first or second part of a UE report of FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of applying a parameter update at a particular time after receiving a first or second part of a UE report could be used without departing from the scope of this disclosure.

In the example of FIG. 25, a UE sends a first part of a UE report 2502 and a second part of the UE report 2504. At 2514, a parameter update is applied at a time T1.

In one embodiment, the update of the parameter is at time T1 from the start of the first part/stage of the UE report 2502. This is illustrated in FIG. 25 Example 1.

In one embodiment, the update of the parameter is at time T1 from the end of the first part/stage of the UE report 2502, this is illustrated in FIG. 25 Example 2.

In one embodiment, the update of the parameter is at time T1 from the start of the second part/stage of the UE report 2504, this is illustrated in FIG. 25 Example 3.

In one embodiment, the update of the parameter is at time T1 from the end of the second part/stage of the UE report 2504. This is illustrated in FIG. 25 Example 4.

Although FIG. 25 illustrates an example an example 2500 of applying a parameter update at a particular time after receiving a first or second part of a UE report, various changes may be made to FIG. 25. For example, while shown as a series of steps, various steps in FIG. 25 could overlap, occur in parallel, occur in a different order, or occur any number of times.

In one embodiment, the update of the parameter is at the first symbol boundary at or after time T1 from the start of the first part/stage of the UE report.

In one embodiment, the update of the parameter is at the first symbol boundary at or after time T1 from the end of the first part/stage of the UE report.

In one embodiment, the update of the parameter is at the first symbol boundary at or after time T1 from the start of the second part/stage of the UE report.

In one embodiment, the update of the parameter is at the first symbol boundary at or after time T1 from the end of the second part/stage of the UE report.

In one embodiment, the update of the parameter is at the first slot boundary at or after time T1 from the start of the first part/stage of the UE report.

In one embodiment, the update of the parameter is at the first slot boundary at or after time T1 from the end of the first part/stage of the UE report.

In one embodiment, the update of the parameter is at the first slot boundary at or after time T1 from the start of the second part/stage of the UE report.

In one embodiment, the update of the parameter is at the first slot boundary at or after time T1 from the end of the second part/stage of the UE report.

In one embodiment, the update of the parameter is at the first sub-frame boundary at or after time T1 from the start of the first part/stage of the UE report.

In one embodiment, the update of the parameter is at the first sub-frame boundary at or after time T1 from the end of the first part/stage of the UE report.

In one embodiment, the update of the parameter is at the first sub-frame boundary at or after time T1 from the start of the second part/stage of the UE report.

In one embodiment, the update of the parameter is at the first sub-frame boundary at or after time T1 from the end of the second part/stage of the UE report.

In one embodiment, the update of the parameter is at the first frame boundary at or after time T1 from the start of the first part/stage of the UE report.

In one embodiment, the update of the parameter is at the first frame boundary at or after time T1 from the end of the first part/stage of the UE report.

In one embodiment, the update of the parameter is at the first frame boundary at or after time T1 from the start of the second part/stage of the UE report.

In one embodiment, the update of the parameter is at the first frame boundary at or after time T1 from the end of the second part/stage of the UE report.

In one embodiment, the update of the parameter is at the first SFN roll-over boundary (SFN=0) at or after time T1 from the start of the first part/stage of the UE report.

In one embodiment, the update of the parameter is at the first SFN roll-over boundary (SFN=0) at or after time T1 from the end of the first part/stage of the UE report.

In one embodiment, the update of the parameter is at the first SFN roll-over boundary (SFN=0) at or after time T1 from the start of the second part/stage of the UE report.

In one embodiment, the update of the parameter is at the first SFN roll-over boundary (SFN=0) at or after time T1 from the end of the second part/stage of the UE report.

In one embodiment, T1 is specified by system specifications and/or configured or updated by RRC signaling and/or MAC CE signaling and/or L1 control (e.g., DCI) signaling.

In one embodiment, T can depend on the sub-carrier spacing of the signal/channel that includes the report and/or acknowledgement (when applicable) and/or BWP or carrier to which the parameter update is associated.

In one embodiment, T1 can depend on a UE capability.

In one embodiment, T1 can be in units of symbols.

In one embodiment, T1 can be in units of slots.

In one embodiment, T1 can be in units of sub-frames.

In one embodiment, T1 can be in units of frames.

In one embodiment, T1 can be in units of time (e.g., millisecond, seconds, etc.).

In one embodiment, a UE report can comprise two parts or two stages. A parameter is updated based on the UE report. The parameter is updated at a time T1, or after a time T1 (for example, first symbol or slot or sub-frame or frame boundary at or after a time T1) from the UE report and after acknowledgement of the UE report. In one example, the acknowledgement can be for the first part/stage only. In one example, the acknowledgment can be for the second part/stage only. In one example, there is an acknowledgment for the first part/stage and an acknowledgement for the second part/stage.

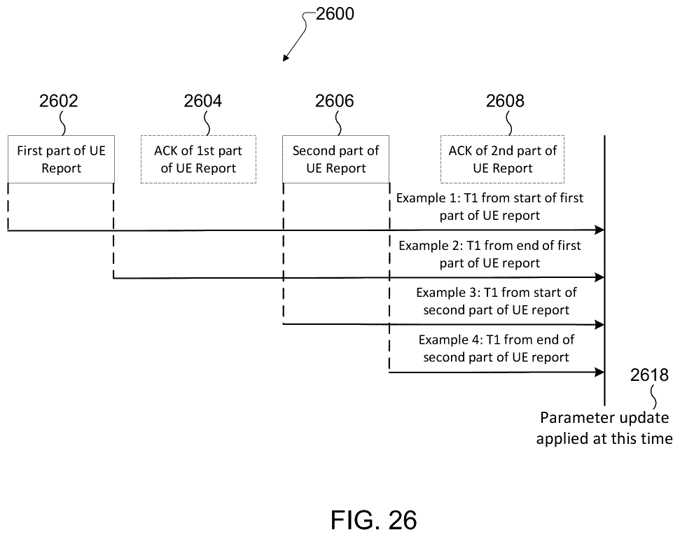

FIG. 26 illustrates an example 2600 of applying a parameter update at a particular time and after acknowledgment of a two stage UE report according to embodiments of the present disclosure. The embodiment of applying a parameter update at a particular time and after acknowledgment of a two stage UE report of FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of applying a parameter update at a particular time and after acknowledgment of a two stage UE report could be used without departing from the scope of this disclosure.

In the example of FIG. 26, a UE sends a first part of a UE report 2602, and receives an acknowledgment 2604 of the first part of the UE report. The UE further sends a second part of the UE report 2606, and receives an acknowledgment 2608 of the second part of the UE report. At 2618, after the receipt of acknowledgement 2604 and/or 2608, a parameter update is applied at a time T1.

In one embodiment, the update of the parameter is at time T1 from the start of the first part/stage of the UE report 2602 as long as the acknowledgement 2604 for the UE report is transmitted by the gNB/TRP/network or the acknowledgement 2604 for the UE report is received by the UE. This is illustrated in FIG. 26 Example 1.

In one embodiment, the update of the parameter is at time T1 from the end of the first part/stage of the UE report 2602 as long as the acknowledgement 2604 for the UE report is transmitted by the gNB/TRP/network or the acknowledgement 2604 for the UE report is received by the UE. This is illustrated in FIG. 26 Example 2.

In one embodiment, the update of the parameter is at time T1 from the start of the second part/stage of the UE report 2606 as long as the acknowledgement 2608 for the UE report is transmitted by the gNB/TRP/network or the acknowledgement 2808 for the UE report is received by the UE. This is illustrated in FIG. 26 Example 3.

In one embodiment, the update of the parameter is at time T1 from the end of the second part/stage of the UE report 2606 as long as the acknowledgement 2608 for the UE report is transmitted by the gNB/TRP/network or the acknowledgement 2608 for the UE report is received by the UE. This is illustrated in FIG. 26 Example 4.

Although FIG. 26 illustrates an example an example 2600 of applying a parameter update at a particular time and after acknowledgment of a two stage UE report, various changes may be made to FIG. 26. For example, while shown as a series of steps, various steps in FIG. 26 could overlap, occur in parallel, occur in a different order, or occur any number of times.

In one embodiment, the update of the parameter is at the first symbol boundary at or after time T1 from the start of the first stage/part of the UE report, and as long as the acknowledgement for the UE report is transmitted by the gNB/TRP/network or the acknowledgement for the UE report is received by the UE.

In one embodiment, the update of the parameter is at the first symbol boundary at or after time T1 from the end of the first stage/part of the UE report, and as long as the acknowledgement for the UE report is transmitted by the gNB/TRP/network or the acknowledgement for the UE report is received by the UE.

In one embodiment, the update of the parameter is at the first symbol boundary at or after time T1 from the start of the second stage/part of the UE report, and as long as the acknowledgement for the UE report is transmitted by the gNB/TRP/network or the acknowledgement for the UE report is received by the UE.

In one embodiment, the update of the parameter is at the first symbol boundary at or after time T1 from the end of the second stage/part of the UE report, and as long as the acknowledgement for the UE report is transmitted by the gNB/TRP/network or the acknowledgement for the UE report is received by the UE.

In one embodiment, the update of the parameter is at the first slot boundary at or after time T1 from the start of the first stage/part of the UE report, and as long as the acknowledgement for the UE report is transmitted by the gNB/TRP/network or the acknowledgement for the UE report is received by the UE.

In one embodiment, the update of the parameter is at the first slot boundary at or after time T1 from the end of the first stage/part of the UE report, and as long as the acknowledgement for the UE report is transmitted by the gNB/TRP/network or the acknowledgement for the UE report is received by the UE.

In one embodiment, the update of the parameter is at the first slot boundary at or after time T1 from the start of the second stage/part of the UE report, and as long as the acknowledgement for the UE report is transmitted by the gNB/TRP/network or the acknowledgement for the UE report is received by the UE.

In one embodiment, the update of the parameter is at the first slot boundary at or after time T1 from the end of the second stage/part of the UE report, and as long as the acknowledgement for the UE report is transmitted by the gNB/TRP/network or the acknowledgement for the UE report is received by the UE.

In one embodiment, the update of the parameter is at the first sub-frame boundary at or after time T1 from the start of the first stage/part of the UE report, and as long as the acknowledgement for the UE report is transmitted by the gNB/TRP/network or the acknowledgement for the UE report is received by the UE.

In one embodiment, the update of the parameter is at the first sub-frame boundary at or after time T1 from the end of the first stage/part of the UE report, and as long as the acknowledgement for the UE report is transmitted by the gNB/TRP/network or the acknowledgement for the UE report is received by the UE.

In one embodiment, the update of the parameter is at the first sub-frame boundary at or after time T1 from the start of the second stage/part of the UE report, and as long as the acknowledgement for the UE report is transmitted by the gNB/TRP/network or the acknowledgement for the UE report is received by the UE.

In one embodiment, the update of the parameter is at the first sub-frame boundary at or after time T1 from the end of the second stage/part of the UE report, and as long as the acknowledgement for the UE report is transmitted by the gNB/TRP/network or the acknowledgement for the UE report is received by the UE.

In one embodiment, the update of the parameter is at the first frame boundary at or after time T1 from the start of the first stage/part of the UE report, and as long as the acknowledgement for the UE report is transmitted by the gNB/TRP/network or the acknowledgement for the UE report is received by the UE.

In one embodiment, the update of the parameter is at the first frame boundary at or after time T1 from the end of the first stage/part of the UE report, and as long as the acknowledgement for the UE report is transmitted by the gNB/TRP/network or the acknowledgement for the UE report is received by the UE.

In one embodiment, the update of the parameter is at the first frame boundary at or after time T1 from the start of the second stage/part of the UE report, and as long as the acknowledgement for the UE report is transmitted by the gNB/TRP/network or the acknowledgement for the UE report is received by the UE.

In one embodiment, the update of the parameter is at the first frame boundary at or after time T1 from the end of the second stage/part of the UE report, and as long as the acknowledgement for the UE report is transmitted by the gNB/TRP/network or the acknowledgement for the UE report is received by the UE.

In one embodiment, the update of the parameter is at the first SFN roll-over boundary (SFN=0) at or after time T1 from the start of the first stage/part of the UE report, and as long as the acknowledgement for the UE report is transmitted by the gNB/TRP/network or the acknowledgement for the UE report is received by the UE.

In one embodiment, the update of the parameter is at the first SFN roll-over boundary (SFN=0) at or after time T1 from the end of the first stage/part of the UE report, and as long as the acknowledgement for the UE report is transmitted by the gNB/TRP/network or the acknowledgement for the UE report is received by the UE.

In one embodiment, the update of the parameter is at the first SFN roll-over boundary (SFN=0) at or after time T1 from the start of the second stage/part of the UE report, and as long as the acknowledgement for the UE report is transmitted by the gNB/TRP/network or the acknowledgement for the UE report is received by the UE.

In one embodiment, the update of the parameter is at the first SFN roll-over boundary (SFN=0) at or after time T1 from the end of the second stage/part of the UE report, and as long as the acknowledgement for the UE report is transmitted by the gNB/TRP/network or the acknowledgement for the UE report is received by the UE.

In one embodiment, T1 is specified by system specifications and/or configured or updated by RRC signaling and/or MAC CE signaling and/or L1 control (e.g., DCI) signaling.

In one embodiment, T1 can depend on the sub-carrier spacing of the signal/channel that includes the report and/or acknowledgement and/or BWP or carrier to which the parameter update is associated.

In one embodiment, T1 can depend on a UE capability.

In one embodiment, T1 can be in units of symbols.

In one embodiment, T1 can be in units of slots.

In one embodiment, T1 can be in units of sub-frames.

In one embodiment, T1 can be in units of frames.

In one embodiment, T1 can be in units of time (e.g., millisecond, seconds, etc.).

In one embodiment, a UE report can comprise two parts or two stages. A parameter is updated based on the UE report. The parameter is updated after a time T1 from the UE report. If no acknowledgement is received by time T2 for the UE report, or if the UE doesn't perceive that the parameter has changed at the gNB by time T2, the UE reverts back to the original parameter setting. In one example, the acknowledgement can be for the first part/stage only. In one example, the acknowledgment can be for the second part/stage only. In one example, there is an acknowledgment for the first part/stage and an acknowledgement for the second part/stage.

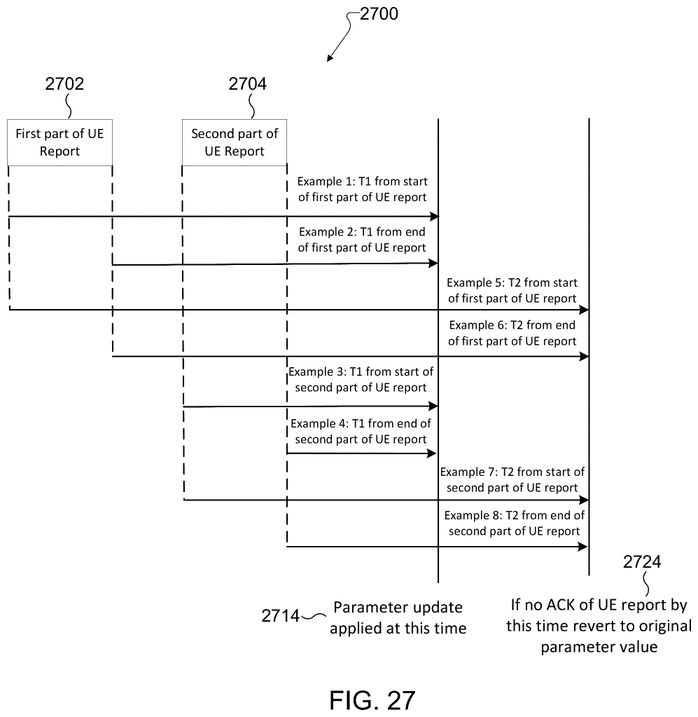

FIG. 27 illustrates an example 2700 of reverting to an original parameter value after failing to receive an acknowledgment of a two stage UE report according to embodiments of the present disclosure. The embodiment of reverting to an original parameter value after failing to receive an acknowledgment of a two stage UE report of FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments of reverting to an original parameter value after failing to receive an acknowledgment of a two stage UE report could be used without departing from the scope of this disclosure.

In the example of FIG. 27, a UE sends a first part of UE report 2702, and a second part of the UE report 2704. At 2714, a parameter update is applied at a time T1, or after a time T1 (for example, first symbol or slot or sub-frame or frame boundary at or after a time T1). At 2724, if no acknowledgement of the UE report has been received by time T2, or after a time T2 (for example, first symbol or slot or sub-frame or frame boundary at or after a time T2), the original parameter value is reverted to.

In one embodiment, the update of the parameter is at time T1 from the start of the first part/stage of the UE report 2702. This is illustrated in FIG. 27 Example 1.

In one embodiment, the update of the parameter is at time T1 from the end of the first part/stage of the UE report 2702. This is illustrated in FIG. 27 Example 2.

In one embodiment, the update of the parameter is at time T1 from the start of the second part/stage of the UE report 2704. This is illustrated in FIG. 27 Example 3.

In one embodiment, the update of the parameter is at time T1 from the end of the second part/stage of the UE report 2704. This is illustrated in FIG. 27 Example 4.

In one embodiment, the parameter reverts back to the original value (original parameter setting) at (or at or after) time T2 from the start of the first part/stage of the UE report 2702, if no acknowledgement is received for the UE report, or if the UE doesn't perceive that the parameter has changed at the gNB. This is illustrated in FIG. 27 Example 5.

In one embodiment, the parameter reverts back to the original value (original parameter setting) at (or at or after) time T2 from the end of the first part/stage of the UE report 2702, if no acknowledgement is received for the UE report, or if the UE doesn't perceive that the parameter has changed at the gNB. This is illustrated in FIG. 27 Example 6.

In one embodiment, the parameter reverts back to the original value (original parameter setting) at (or at or after) time T2 from the start of the second part/stage of the UE report 2704, if no acknowledgement is received for the UE report, or if the UE doesn't perceive that the parameter has changed at the gNB. This is illustrated in FIG. 27 Example 7.

In one embodiment, the parameter reverts back to the original value (original parameter setting) at (or at or after) time T2 from the end of the second part/stage of the UE report 2704, if no acknowledgement is received for the UE report, or if the UE doesn't perceive that the parameter has changed at the gNB. This is illustrated in FIG. 27 Example 8.

Although FIG. 27 illustrates an example an example 2300 of reverting to an original parameter value after failing to receive an acknowledgment of a two stage UE report, various changes may be made to FIG. 27. For example, while shown as a series of steps, various steps in FIG. 27 could overlap, occur in parallel, occur in a different order, or occur any number of times.

In one embodiment, the update of the parameter is at the first symbol boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first symbol boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first symbol boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first symbol boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first slot boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first slot boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first slot boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first slot boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first sub-frame boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first sub-frame boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first sub-frame boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first sub-frame boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first frame boundary at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first frame boundary at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first frame boundary at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first frame boundary at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first SFN roll-over boundary (SFN=0) at or after time T1 from the start of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first SFN roll-over boundary (SFN=0) at or after time T1 from the end of the first part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first SFN roll-over boundary (SFN=0) at or after time T1 from the start of the second part/stage of the UE report. If no acknowledgement is received by time T2 for the UE report, or if the UE doesn't perceive that the parameter has changed at the gNB by time T2, the UE reverts back to the original parameter setting.

In one embodiment, the update of the parameter is at the first SFN roll-over boundary (SFN=0) at or after time T1 from the end of the second part/stage of the UE report. If no acknowledgement is received by time T2 for the UE report, or if the UE doesn't perceive that the parameter has changed at the gNB by time T2, the UE reverts back to the original parameter setting.

In one embodiment, T1 and/or T2 is/are specified by system specifications and/or configured or updated by RRC signaling and/or MAC CE signaling and/or L1 control (e.g., DCI) signaling.

In one embodiment, T1 and/or T2 can depend on the sub-carrier spacing of the signal/channel that includes the report and/or acknowledgement and/or BWP or carrier to which the parameter update is associated.

In one embodiment, T1 and/or T2 can depend on a UE capability.

In one embodiment, T1 and/or T2 can be in units of symbols.

In one embodiment, T1 and/or T2 can be in units of slots.

In one embodiment, T1 and/or T2 can be in units of sub-frames.

In one embodiment, T1 and/or T2 can be in units of frames.

In one embodiment, T1 and/or T2 can be in units of time (e.g., millisecond, seconds, etc.).

In one embodiment, a UE report can comprise two parts or two stages. A parameter is updated based on the UE report. The parameter is updated after a time T1 from the acknowledgment of the UE report. In one example, the acknowledgement can be for the first part/stage only. In one example, the acknowledgment can be for the second part/stage only. In one example, there is an acknowledgment for the first part/stage and an acknowledgement for the second part/stage.

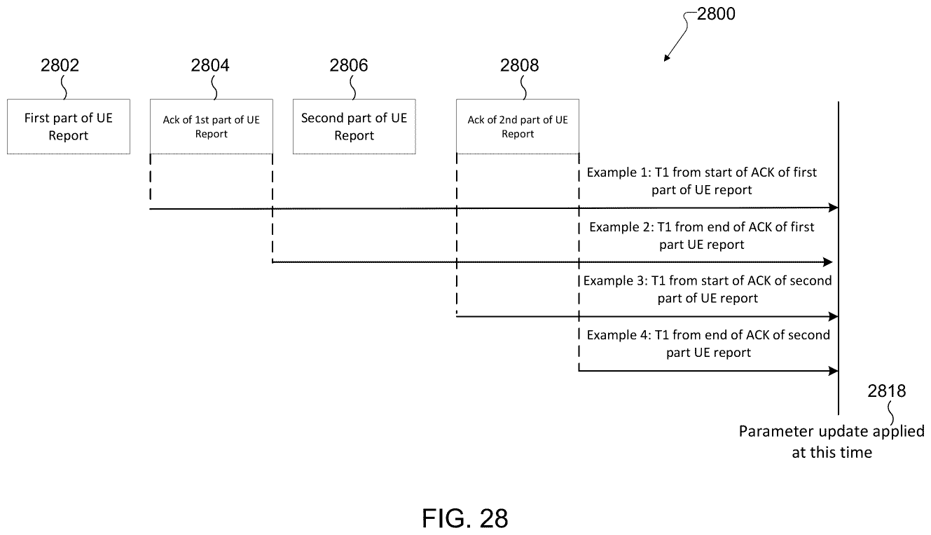

FIG. 28 illustrates an example 2800 of applying a parameter update at a particular time after acknowledgment of a two stage UE report according to embodiments of the present disclosure. The embodiment of applying a parameter update at a particular time after acknowledgment of a two stage UE report of FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of applying a parameter update at a particular time after acknowledgment of a two stage UE report could be used without departing from the scope of this disclosure.

In the example of FIG. 28, a UE sends a first part of a UE report 2402, and receives an acknowledgment 2804 of the first part of the UE report. The UE furthers sends a second part of the UE report 2806, and receives an acknowledgment 280 of the second part of the UE report. At 2818, a parameter update is applied at a time T1, or after a time T1 (for example, first symbol or slot or sub-frame or frame boundary at or after a time T1) after the receipt of acknowledgement 2804 and/or 2808.

In one embodiment, the update of the parameter is at time T1 from the start of the acknowledgement 2804 of the first part/stage of the UE report. This is illustrated in FIG. 28 Example 1.

In one embodiment, the update of the parameter is at time T1 from the end of the acknowledgement 2804 of the first part/stage of the UE report. This is illustrated in FIG. 28 Example 2.

In one embodiment, the update of the parameter is at time T1 from the start of the acknowledgement 2806 of the second part/stage of the UE report. This is illustrated in FIG. 28 Example 3.

In one embodiment, the update of the parameter is at time T1 from the end of the acknowledgement 2808 of the second part/stage of the UE report. This is illustrated in FIG. 28 Example 4).

Although FIG. 28 illustrates an example an example 2800 of applying a parameter update at a particular time after acknowledgment of a two stage UE report, various changes may be made to FIG. 28. For example, while shown as a series of steps, various steps in FIG. 28 could overlap, occur in parallel, occur in a different order, or occur any number of times.

In one embodiment, the update of the parameter is at the first symbol boundary at or after time T1 from the start of the acknowledgement of the first part/stage of the UE report.

In one embodiment, the update of the parameter is at the first symbol boundary at or after time T1 from the end of the acknowledgement of the first part/stage of the UE report.

In one embodiment, the update of the parameter is at the first symbol boundary at or after time T1 from the start of the acknowledgement of the second part/stage of the UE report.

In one embodiment, the update of the parameter is at the first symbol boundary at or after time T1 from the end of the acknowledgement of the second part/stage of the UE report.

In one embodiment, the update of the parameter is at the first slot boundary at or after time T1 from the start of the acknowledgement of the first part/stage of the UE report.

In one embodiment, the update of the parameter is at the first slot boundary at or after time T1 from the end of the acknowledgement of the first part/stage of the UE report.

In one embodiment, the update of the parameter is at the first slot boundary at or after time T1 from the start of the acknowledgement of the second part/stage of the UE report.

In one embodiment, the update of the parameter is at the first slot boundary at or after time T1 from the end of the acknowledgement of the second part/stage of the UE report.

In one embodiment, the update of the parameter is at the first sub-frame boundary at or after time T1 from the start of the acknowledgement of the first part/stage of the UE report.

In one embodiment, the update of the parameter is at the first sub-frame boundary at or after time T1 from the end of the acknowledgement of the first part/stage of the UE report.

In one embodiment, the update of the parameter is at the first sub-frame boundary at or after time T1 from the start of the acknowledgement of the second part/stage of the UE report.

In one embodiment, the update of the parameter is at the first sub-frame boundary at or after time T1 from the end of the acknowledgement of the second part/stage of the UE report.

In one embodiment, the update of the parameter is at the first frame boundary at or after time T1 from the start of the acknowledgement of the first part/stage of the UE report.

In one embodiment, the update of the parameter is at the first frame boundary at or after time T1 from the end of the acknowledgement of the first part/stage of the UE report.

In one embodiment, the update of the parameter is at the first frame boundary at or after time T1 from the start of the acknowledgement of the second part/stage of the UE report.

In one embodiment, the update of the parameter is at the first frame boundary at or after time T1 from the end of the acknowledgement of the second part/stage of the UE report.

In one embodiment, the update of the parameter is at the first SFN roll-over boundary (SFN=0) at or after time T1 from the start of the acknowledgement of the first part/stage of the UE report.

In one embodiment, the update of the parameter is at the first SFN roll-over boundary (SFN=0) at or after time T1 from the end of the acknowledgement of the first part/stage of the UE report.

In one embodiment, the update of the parameter is at the first SFN roll-over boundary (SFN=0) at or after time T1 from the start of the acknowledgement of the second part/stage of the UE report.

In one embodiment, the update of the parameter is at the first SFN roll-over boundary (SFN=0) at or after time T1 from the end of the acknowledgement of the second part/stage of the UE report.

In one embodiment, T1 is specified by system specifications and/or configured or updated by RRC signaling and/or MAC CE signaling and/or L1 control (e.g., DCI) signaling.

In one embodiment, T can depend on the sub-carrier spacing of the signal/channel that includes the report and/or acknowledgement and/or BWP or carrier to which the parameter update is associated.

In one embodiment, T1 can depend on a UE capability.

In one embodiment, T1 can be in units of symbols.

In one embodiment, T1 can be in units of slots.

In one embodiment, T1 can be in units of sub-frames.

In one embodiment, T1 can be in units of frames.

In one embodiment, T1 can be in units of time (e.g., millisecond, seconds, etc.).

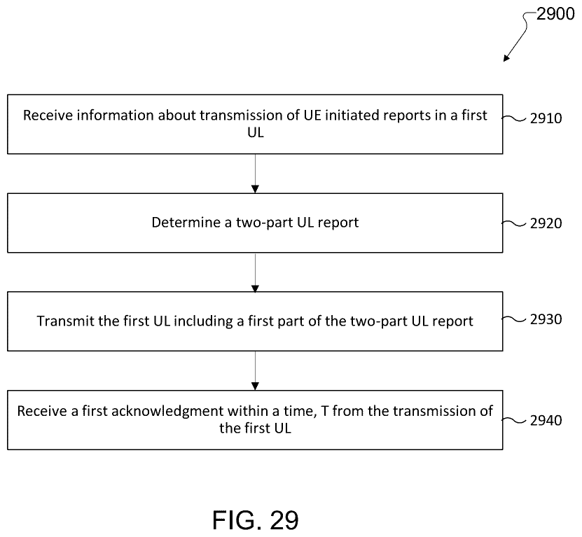

FIG. 29 illustrates a method 2900 for acknowledgment of UE initiated reporting according to embodiments of the present disclosure. An embodiment of the method illustrated in FIG. 29 is for illustration only. One or more of the components illustrated in FIG. 29 may be implemented in specialized circuitry configured to perform the noted functions or one or more of the components may be implemented by one or more processors executing instructions to perform the noted functions. Other embodiments of acknowledgment of UE initiated reporting could be used without departing from the scope of this disclosure.

As illustrated in FIG. 29, the method 2900 begins at step 2910. At step 2910, a UE receives information about transmission of UE initiated reports in a first uplink (UL). In one example, multiple report configurations are configured, wherein a UE can select a configuration based on the report payload size and/or the report type. At step 2920, the UE determines a two-part UL report. At step 2930, the UE transmits the first UL including a first part of the two-part UL report. The transmission is based on the information received in step 2910. Finally, at step 2940, the UE receives a first acknowledgment. The acknowledgment is received within a time, T from the transmission of the first UL.

Although FIG. 29 illustrates one example of a method 2900 for acknowledgment of UE initiated reporting, various changes may be made to FIG. 29. For example, while shown as a series of steps, various steps in FIG. 29 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE), comprising:
a transceiver configured to receive information about transmission of UE initiated reports in a first uplink (UL); and
a processor operably coupled to the transceiver, the processor configured to determine a two-part UL report,
wherein the transceiver is further configured to:
transmit, based on the information, the first UL including a first part of the two-part UL report; and
receive a first acknowledgment within a time, T from the transmission of the first UL.

2. The UE of claim 1, wherein the transceiver is further configured to re-transmit the first UL when the first acknowledgment is not received within the time, T.

3. The UE of claim 1, wherein the first acknowledgment is conveyed in a downlink control information (DCI) format in a physical downlink control channel (PDCCH).

4. The UE of claim 3, wherein:
the DCI format includes scheduling information for transmission of a second UL; and
the transceiver is further configured to:
transmit, based on the scheduling information, the second UL including a second part of the two-part UL report; and
receive a second acknowledgment associated with the second UL.

5. The UE of claim 4, wherein:
the transceiver is further configured to receive a time, T2; and
the processor is further configured to update a parameter based on the two-part UL report at the time, T2, from the second acknowledgment.

6. The UE of claim 1, wherein the first UL includes a second part of the two-part UL report.

7. The UE of claim 1, wherein:
the transceiver is further configured to receive a time, T2; and
the processor is further configured to update a parameter based on the two-part UL report at the time, T2, from the first acknowledgment.

8. A base station (BS), comprising:
a transceiver configured to:
transmit information about transmission of user equipment (UE) initiated reports in a first uplink (UL); and
receive, based on the information, the first UL including a first part of a two-part UL report; and
a processor operably coupled to the transceiver, the processor configured to determine a first acknowledgment for the first UL,
wherein the transceiver is further configured to:
transmit the first acknowledgment within a time, T from the reception of the first UL.

9. The BS of claim 8, wherein the first acknowledgment is conveyed in a downlink control information (DCI) format in a physical downlink control channel (PDCCH).

10. The BS of claim 9, wherein:
the processor is further configured to determine scheduling information for a second UL;
the DCI format includes the scheduling information; and
the transceiver is further configured to:
receive, based on the scheduling information, the second UL including a second part of the two-part UL report; and
transmit a second acknowledgment associated with the second UL.

11. The BS of claim 10, wherein:
the transceiver is further configured to transmit a time, T2; and
the processor is further configured to update a parameter based on the two-part UL report at the time, T2, from the second acknowledgment.

12. The BS of claim 8, wherein the first UL includes a second part of the two-part UL report.

13. The BS of claim 8, wherein:
the transceiver is further configured to transmit a time, T2; and
the processor is further configured to update a parameter based on the two-part UL report at the time, T2, from the first acknowledgment.

14. A method of operating a user equipment (UE), the method comprising:
receiving information about transmission of UE initiated reports in a first uplink (UL);
determining a two-part UL report;
transmitting, based on the information, the first UL including a first part of the two-part UL report; and
receiving a first acknowledgment within a time, T from the transmission of the first UL.

15. The method of claim 14, further comprising:
re-transmitting the first UL when the first acknowledgment is not received within the time, T.

16. The method of claim 14, wherein the first acknowledgment is conveyed in a downlink control information (DCI) format in a physical downlink control channel (PDCCH).

17. The method of claim 16, wherein:
the DCI format includes scheduling information for transmission of a second UL; and
wherein the method further comprises:
transmitting, based on the scheduling information, the second UL including a second part of the two-part UL report; and
receiving a second acknowledgment associated with the second UL.

18. The method of claim 17, further comprising:
receiving a time, T2; and
updating a parameter based on the two-part UL report at the time, T2, from the second acknowledgment.

19. The method of claim 14, wherein the first UL includes a second part of the two-part UL report.

20. The method of claim 14, further comprising:
receiving a time, T2; and
updating a parameter based on the two-part UL report at the time, T2, from the first acknowledgment.
